(19) United States
(12) Patent Application Publication
(10) Pub. No.: US 2018/0357076 A1
(43) Pub. Date: Dec. 13, 2018

(54) METHOD TO ESTABLISH OPERATING CONFIGURATION IN A VGMI INTERFACE

(71) Applicant: QUALCOMM Incorporated, San Diego, CA (US)

(72) Inventors: Richard Dominic WIETFELDT, San Diego, CA (US); Lalan Jee MISHRA, San Diego, CA (US)

(21) Appl. No.: 16/004,002

(22) Filed: Jun. 8, 2018

Related U.S. Application Data
(60) Provisional application No. 62/518,393, filed on Jun. 12, 2017.

(51) Int. Cl. G06F 9/445; G06F 13/10

(52) U.S. Cl. CPC G06F 9/44505; G06F 2009/45579; G06F 13/102

(57) ABSTRACT

In an aspect, an apparatus initializes a virtual general-purpose input/output and messaging interface based on at least one of a first mode configuration setting or a first protocol configuration setting. The apparatus is able to communicate with a device over the virtual general-purpose input/output and messaging interface using at least one of the first mode configuration setting or the first protocol configuration setting. The apparatus changes the first mode configuration setting of the virtual general-purpose input/output and messaging interface to a second mode configuration setting and/or changes the first protocol configuration setting of the virtual general-purpose input/output and messaging interface to a second protocol configuration setting. The apparatus communicates with the device over the virtual general-purpose input/output and messaging interface using at least one of the second mode configuration setting or the second protocol configuration setting.

### CLAIM OF PRIORITY UNDER 35 U.S.C. § 119

The present Application for Patent claims priority to U.S. Provisional Application No. 62/518,393 entitled “METHOD TO ESTABLISH OPERATING CONFIGURATION IN A VGMI INTERFACE” filed Jun. 12, 2017, which is assigned to the assignee hereof and hereby expressly incorporated by reference herein.

### INTRODUCTION

### Field of the Disclosure

Aspects of the disclosure relate generally to a method to establish operating configuration in a VGMI interface.

### BACKGROUND

The Virtual General-Purpose Input/Output and Messaging Interface (VGI or VGMI) is a Mobile Industry Processor Interface (MIPI) specification. The specification for VGMI provides a number of operating modes, such as 2-wire vs. 3-wire, 2-wire with a frequency of 4 MHz (pulse width modulation (PWM)) vs. 8 MHz (phase modulated pulse width modulation (PM-PWM)), a default mode with 2-wire PWM and two-bit VGMI function bit length (Type-1 protocol as described herein), and/or 2-wire PWM vs. PM-PWM vs. universal asynchronous receiver/transmitter (UART) signaling. Many other operating modes may be available. The specification for VGMI defines power up in a default configuration, where the default mode may be PWM, 4 Mbps, and the default protocol may be a 2-bit Type-1 protocol. The PWM mode is selected to service simple devices that may not have an oversampling oscillator to sample the incoming bit stream (like a UART has, typically x16 oversampling). The specification for VGMI, however, does not provide a standardized method for changing configuration settings (e.g., for the above described protocols and operating modes) after power up. For example, configuration settings are left to an off-line agreement between the interconnected devices.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In an aspect, a method for an apparatus (also referred to herein as a first device) is disclosed. The first device initializes a virtual general-purpose input/output and messaging interface based on at least one of a first mode configuration setting or a first protocol configuration setting, wherein the first device is able to communicate with a second device over the virtual general-purpose input/output and messaging interface using at least one of the first mode configuration setting or the first protocol configuration setting. The first device changes the first mode configuration setting of the virtual general-purpose input/output and messaging interface to a second mode configuration setting and/or changes the first protocol configuration setting of the virtual general-purpose input/output and messaging interface to a second protocol configuration setting. The first device communicates with the second device over the virtual general-purpose input/output and messaging interface using at least one of the second mode configuration setting or the second protocol configuration setting.

In an aspect of the disclosure, changing the first mode configuration setting and/or the first protocol configuration setting includes obtaining at least one of the second mode configuration setting or the second protocol configuration setting for the virtual general-purpose input/output and messaging interface, and writing at least one of the second mode configuration setting or the second protocol configuration setting to a virtual general-purpose input/output and messaging interface configuration register. In an aspect of the disclosure, writing at least one of the second mode configuration setting or the second protocol configuration setting to the virtual general-purpose input/output and messaging interface configuration register includes transmitting a first virtual general-purpose input/output and messaging interface packet that includes a mode configuration register address and the second mode configuration setting, or transmitting a second virtual general-purpose input/output and messaging interface packet that includes a protocol configuration register address and the second protocol configuration setting. In an aspect of the disclosure, each of the mode configuration register address, the second mode configuration setting, the protocol configuration register address, and the second protocol configuration setting are 1-byte in length.

In an aspect of the disclosure, the first device obtains mode information for at least the second device from a mode-support capability register to determine one or more modes supported by at least the second device, wherein the second mode configuration setting is based on the mode information. In an aspect of the disclosure, the first device determines that the one or more modes supported by at least the second device are compatible with the first device. In an aspect of the disclosure, the first device exchanges device capabilities with at least the second device. In an aspect of the disclosure, the first device stores a favored operating configuration mode for the virtual general-purpose input/output and messaging interface in a non-volatile memory of the first device, and transmits the favored operating configuration mode to at least the second device after a reset of the first device, wherein the first device is a host processor (e.g., a host SoC). In some aspects of the disclosure, the second device may be a peripheral device (e.g., an accelerometer and magnetometer device, a fingerprint sensor device, an analog to digital converter device, or other suitable peripheral device).

In an aspect of the disclosure, the mode information in the mode-support capability register is based on at least one of one or more configuration pins of the second device, available information for the second device, or a one time programmable read location. In an aspect of the disclosure, the second mode configuration setting includes one or more operating modes for the virtual general-purpose input/output and messaging interface. In an aspect of the disclosure, the second protocol configuration setting indicates a 2-bit function bit length, a 3-bit function bit length, or a 10-bit function bit length for communication of packets over the virtual general-purpose input/output and messaging interface.

In an aspect of the disclosure, the first device exchanges one or more configuration registers with at least the second device, and transmits a known test message to at least the second device after changing the first mode configuration setting and/or the first protocol configuration setting of the virtual general-purpose input/output and messaging interface.

In an aspect, an apparatus is disclosed. The apparatus includes a communication interface configured to communicate with one or more peripheral devices and a processing circuit coupled to the communication interface. The processing circuit configured to initialize a virtual general-purpose input/output and messaging interface based on at least one of a first mode configuration setting or a first protocol configuration setting, wherein the processing circuit is able to communicate with a device over the virtual general-purpose input/output and messaging interface using at least one of the first mode configuration setting or the first protocol configuration setting. The processing circuit is further configured to change the first mode configuration setting of the virtual general-purpose input/output and messaging interface to a second mode configuration setting and/or change the first protocol configuration setting of the virtual general-purpose input/output and messaging interface to a second protocol configuration setting, and communicate with the device over the virtual general-purpose input/output and messaging interface using at least one of the second mode configuration setting or the second protocol configuration setting.

In an aspect, an apparatus is disclosed. The apparatus includes means for initializing a virtual general-purpose input/output and messaging interface based on at least one of a first mode configuration setting or a first protocol configuration setting, wherein the apparatus is able to communicate with a device over the virtual general-purpose input/output and messaging interface using at least one of the first mode configuration setting or the first protocol configuration setting. The apparatus further includes means for changing the first mode configuration setting of the virtual general-purpose input/output and messaging interface to a second mode configuration setting and/or changing the first protocol configuration setting of the virtual general-purpose input/output and messaging interface to a second protocol configuration setting, and means for communicating with the device over the virtual general-purpose input/output and messaging interface using at least one of the second mode configuration setting or the second protocol configuration setting.

In an aspect, a processor-readable storage medium is disclosed. The processor-readable storage medium includes one or more instructions which, when executed by at least one processor or state machine of a processing circuit, cause the processing circuit to initialize a virtual general-purpose input/output and messaging interface based on at least one of a first mode configuration setting or a first protocol configuration setting. The processing circuit is able to communicate with a device over the virtual general-purpose input/output and messaging interface using at least one of the first mode configuration setting or the first protocol configuration setting. The one or more instructions further cause the processing circuit to change the first mode configuration setting of the virtual general-purpose input/output and messaging interface to a second mode configuration setting and/or change the first protocol configuration setting of the virtual general-purpose input/output and messaging interface to a second protocol configuration setting, and communicate with the device over the virtual general-purpose input/output and messaging interface using at least one of the second mode configuration setting or the second protocol configuration setting.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device that employs a radio frequency front-end control interface (RFFE) bus to couple various radio frequency front-end devices.

FIG. 4 illustrates a device that employs an I3C bus to couple various front-end devices in accordance with certain aspects disclosed herein.

FIG. 5 illustrates an apparatus that includes an Application Processor and multiple peripheral devices that may be adapted according to certain aspects disclosed herein.

FIG. 6 illustrates an apparatus that has been adapted to support Virtual General-Purpose Input/Output (VGPIO) in accordance with certain aspects disclosed herein.

FIG. 7 illustrates examples of broadcast frames for carrying Virtual General-Purpose Input/Output Interface (VGI)/VGPIO information on an I3C interface according to certain aspects disclosed herein.

FIG. 8 illustrates examples of directed frames for carrying VGI/VGPIO information on an I3C interface according to certain aspects disclosed herein.

FIG. 9 illustrates configuration registers that may be associated with a physical pin according to certain aspects disclosed herein.

FIG. 10 illustrates a first device in communication with a second device.

FIG. 11 shows an example VGMI packet for communication of VGPIO signals or message signals.

FIG. 12 shows an example VGMI packet for communication of VGPIO signals or message signals.

FIG. 13 shows an example VGMI packet for communication of VGPIO signals or message signals.

FIG. 14 is an example flowchart for reconfiguring a VGMI interface in accordance with the various aspects of the disclosure.

FIG. 15 is a diagram illustrating example configurations of a VGMI interface after initialization in accordance with various aspects of the disclosure.

FIG. 16 shows an example implementation of a virtual channel configuration register in accordance with various aspects of the disclosure.

FIG. 17 is an illustration of an address and data payload structure for setting a VGMI configuration register.

FIG. 18 is an illustration of a VGMI packet structure for setting a protocol configuration register in accordance with various aspects of the disclosure.

FIG. 19 is an illustration of a VGMI packet structure for setting a mode configuration register in accordance with various aspects of the disclosure.

FIG. 20 is block diagram illustrating select components of an apparatus according to at least one example of the disclosure.

FIG. 21 (including FIGS. 21A and 21B) is a flowchart illustrating a method for an apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

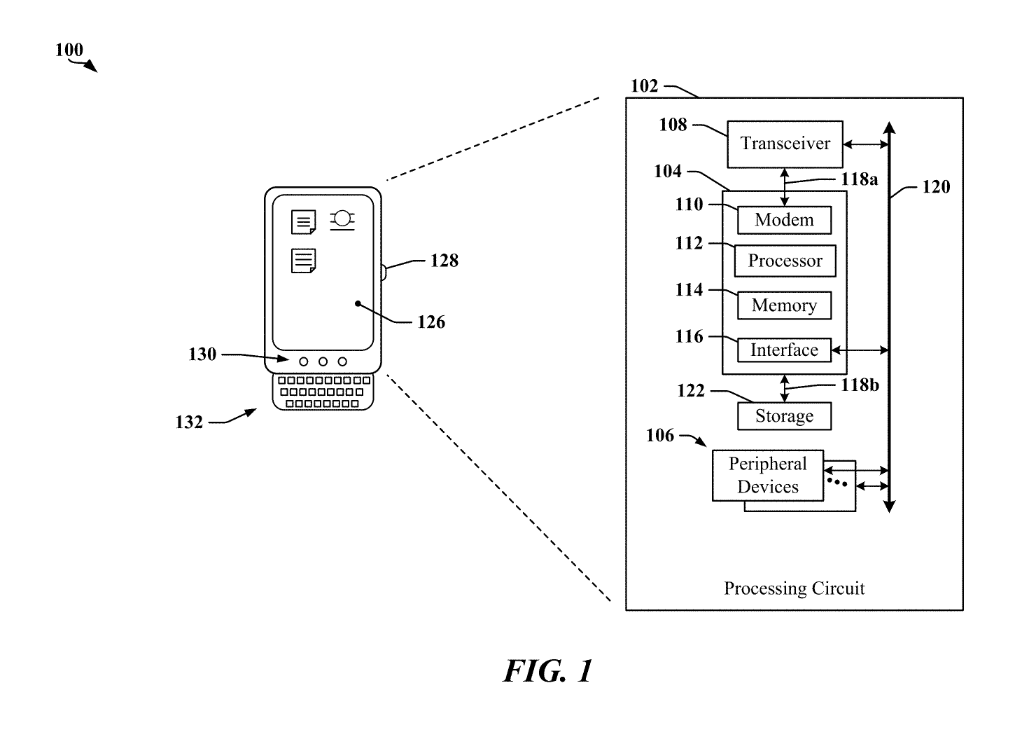

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

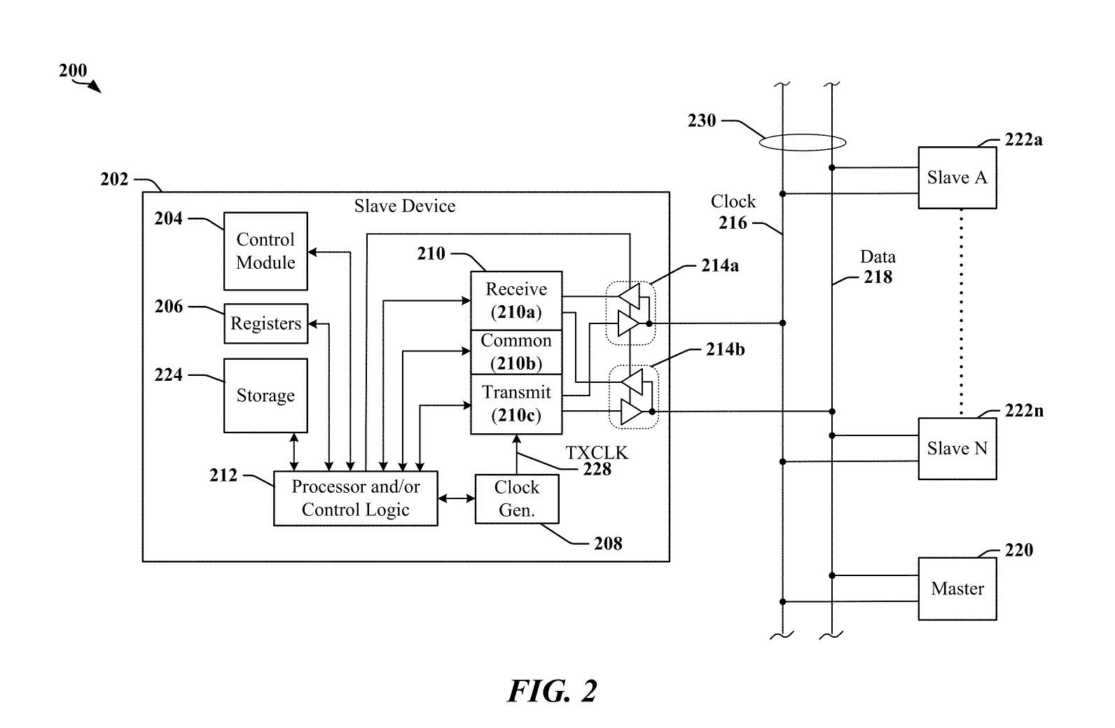

FIG. 2 illustrates certain aspects of an apparatus 200 that includes multiple devices 202, 220 and 222a-222n connected to a serial bus 230. The devices 202, 220 and 222a-222n may include one or more semiconductor IC devices, such as an applications processor, SoC or ASIC. Each of the devices 202, 220 and 222a-222n may include, support or operate as a modem, a signal processing device, a display driver, a camera, a user interface, a sensor, a sensor controller, a media player, a transceiver, and/or other such components or devices. Communications between devices 202, 220 and 222a-222n over the serial bus 230 is controlled by a bus master 220. Certain types of bus can support multiple bus masters 220.

The apparatus 200 may include multiple devices 202, 220 and 222a-222n that communicate when the serial bus 230 is operated in accordance with I2C, I3C or other protocols. At least one device 202, 222a-222n may be configured to operate as a slave device on the serial bus 230. In one example, a slave device 202 may be adapted to provide a control function 204. In some examples, the control function 204 may include circuits and modules that support a display, an image sensor, and/or circuits and modules that control and communicate with one or more sensors that measure environmental conditions. The slave device 202 may include configuration registers 206 or other storage 224, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing in one or more signals 228 provided by a clock generation circuit 208.

Two or more of the devices 202, 220 and/or 222a-222n may be adapted according to certain aspects and features disclosed herein to support a plurality of different communication protocols over a common bus, which may include an I2C and/or I3C protocol. In some instances, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the serial bus 230, and/or alternating current (AC) characteristics affecting certain timing aspects of signals transmitted on the serial bus 230. In some examples, a 2-wire serial bus 230 transmits data on a first wire 218 and a clock signal on a second wire 216. In some instances, data may be encoded in the signaling state, or transitions in signaling state of the first wire 218 and the second wire 216.

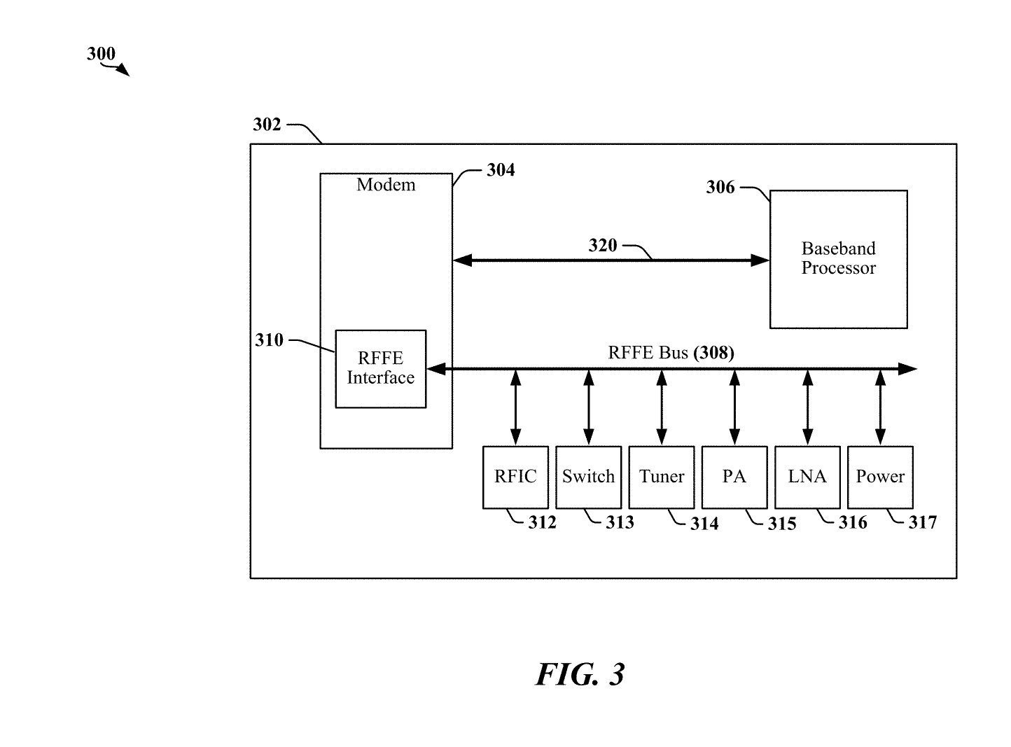

FIG. 3 is a block diagram 300 illustrating an example of a device 302 that employs an RFFE bus 308 to couple various front-end devices 312-317. A modem 304 may include an RFFE interface 310 that couples the modem 304 to the RFFE bus 308. The modem 304 may communicate with a baseband processor 306. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like. In various examples, the device 302 may be implemented with one or more baseband processors 306, modems 304, multiple communications links 308, 320, and various other busses, devices and/or different functionalities. In the example illustrated in FIG. 3, the RFFE bus 308 may be coupled to an RF integrated circuit (RFIC) 312, which may include one or more controllers, and/or processors that configure and control certain aspects of the RF front-end. The RFFE bus 308 may couple the RFIC 312 to a switch 313, an RF tuner 314, a power amplifier (PA) 315, a low noise amplifier (LNA) 316 and a power management module 317.

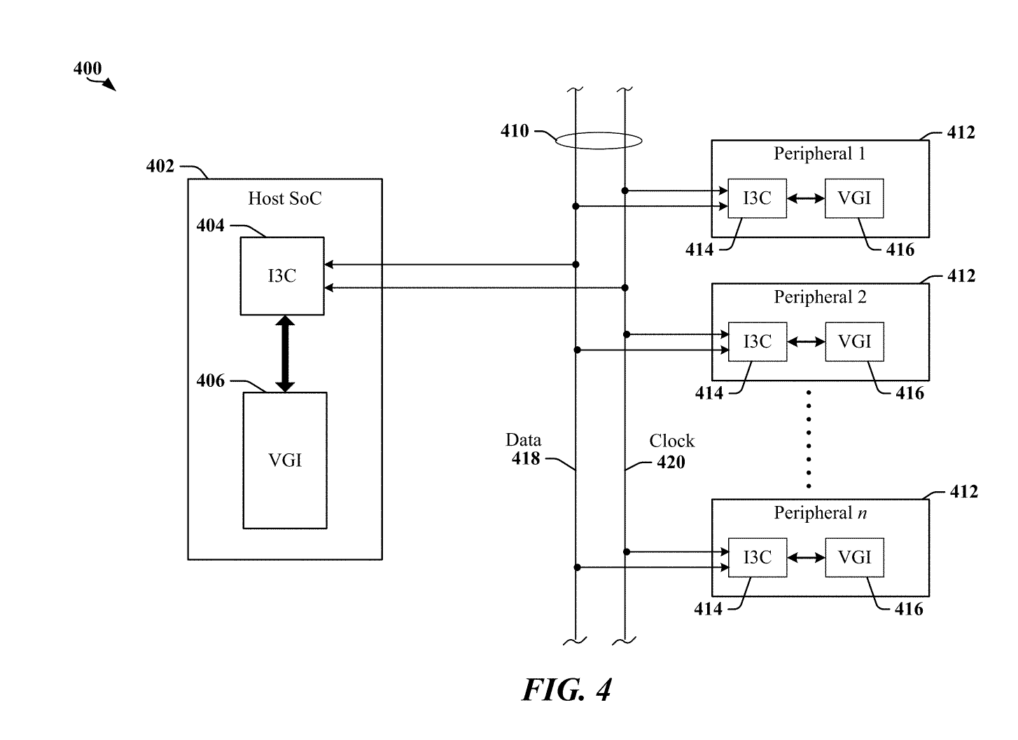

FIG. 4 illustrates an example of an apparatus 400 that uses an I3C bus to couple various devices including a host SoC 402 and a number of peripheral devices 412. The host SoC 402 may include a virtual GPIO finite state machine (VGI FSM 406) and an I3C interface 404, where the I3C interface 404 cooperates with corresponding I3C interfaces 414 in the peripheral devices 412 to provide a communication link between the host SoC 402 and the peripheral devices 412. Each peripheral device 412 includes a VGI FSM 416. In the illustrated example, communications between the SoC 402 and a peripheral device 412 may be serialized and transmitted over a multi-wire serial bus 410 in accordance with an I3C protocol. In other examples, the host SoC 402 may include other types of interface, including I2C and/or RFFE interfaces. In other examples, the host SoC 402 may include a configurable interface that may be employed to communicate using I2C, I3C, RFFE and/or another suitable protocol. In some examples, a multi-wire serial bus 410, such as an I2C or I3C bus, may transmit a data signal over a data wire 418 and a clock signal over a clock wire 420.

### Signaling Virtual GPIO Configuration Information

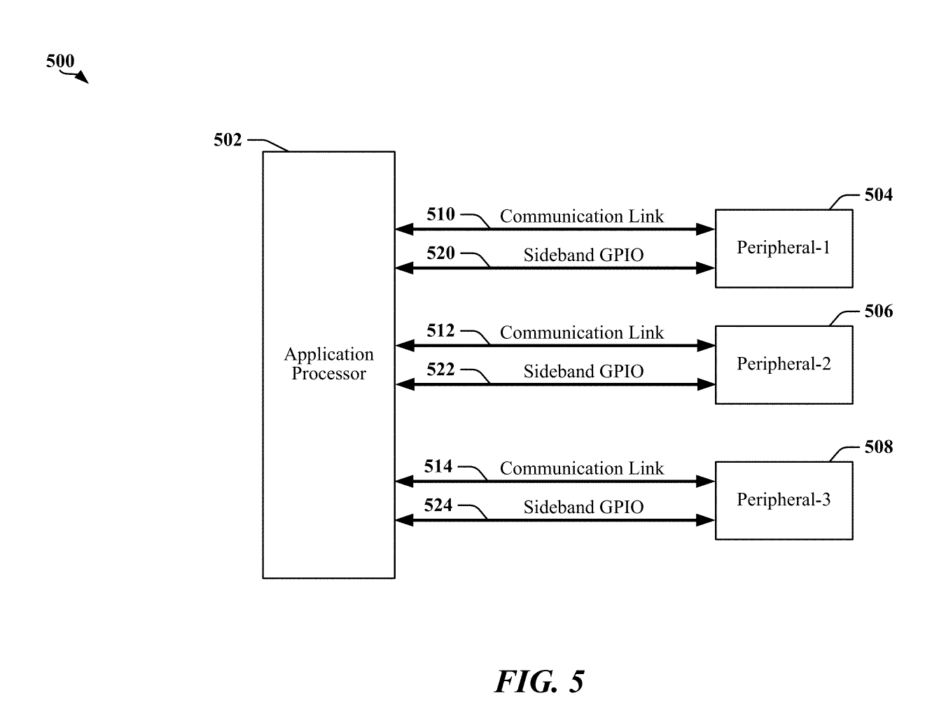

Mobile communication devices, and other devices that are related or connected to mobile communication devices, increasingly provide greater capabilities, performance and functionalities. In many instances, a mobile communication device incorporates multiple IC devices that are connected using a variety of communications links. FIG. 5 illustrates an apparatus 500 that includes an Application Processor 502 and multiple peripheral devices 504, 506, 508. In the example, each peripheral device 504, 506, 508 communicates with the Application Processor 502 over a respective communication link 510, 512, 514 operated in accordance with mutually different protocols. Communication between the Application Processor 502 and each peripheral device 504, 506, 508 may involve additional wires that carry control or command signals between the Application Processor 502 and the peripheral devices 504, 506, 508. These additional wires may be referred to as sideband general purpose input/output (sideband GPIO 520, 522, 524), and in some instances the number of connections needed for sideband GPIO 520, 522, 524 can exceed the number of connections used for a communication link 510, 512, 514.

GPIO provides generic pins/connections that may be customized for particular applications. For example, a GPIO pin may be programmable to function as an output, input pin or a bidirectional pin, in accordance with application needs. In one example, the Application Processor 502 may assign and/or configure a number of GPIO pins to conduct handshake signaling or inter-processor communication (IPC) with a peripheral device 504, 506, 508 such as a modem. When handshake signaling is used, sideband signaling may be symmetric, where signaling is transmitted and received by the Application Processor 502 and a peripheral device 504, 506, 508. With increased device complexity, the increased number of GPIO pins used for IPC communication may significantly increase manufacturing cost and limit GPIO availability for other system-level peripheral interfaces.

According to certain aspects, the state of GPIO, including GPIO associated with a communication link, may be captured, serialized and transmitted over a data communication link. In one example, captured GPIO may be transmitted in packets over an I3C bus using common command codes to indicate packet content and/or destination.

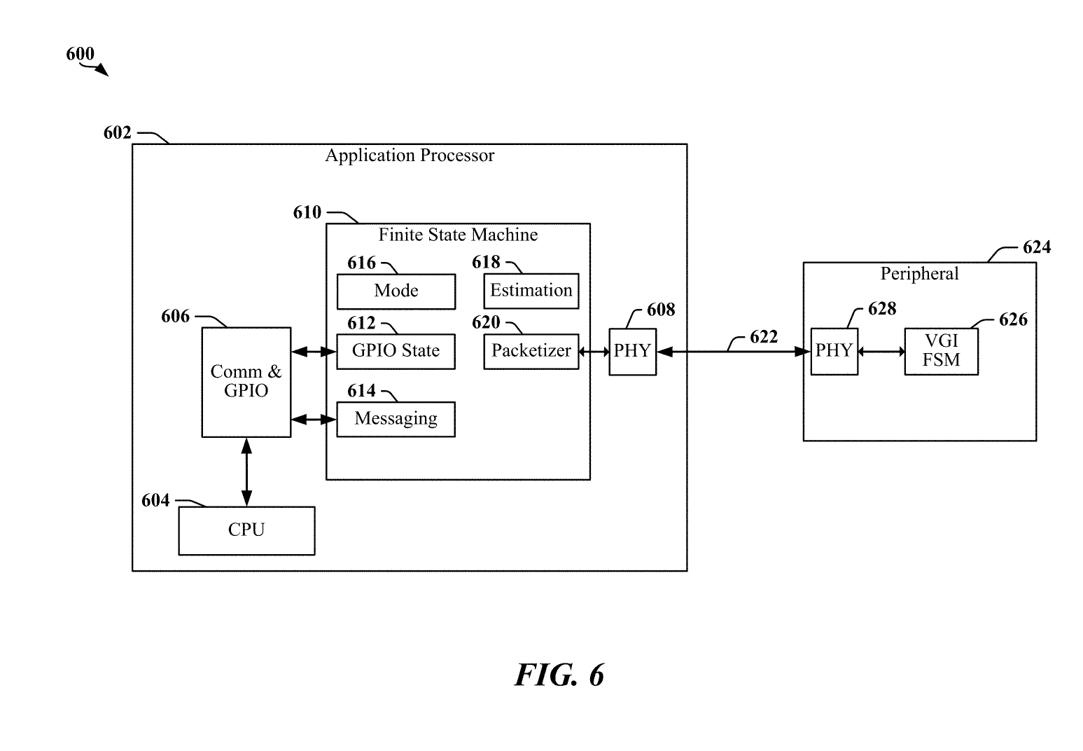

FIG. 6 illustrates an apparatus 600 that is adapted to support Virtual GPIO (VGI or VGMI) in accordance with certain aspects disclosed herein. VGI circuits and techniques can reduce the number of physical pins and connections used to connect an Application Processor 602 with a peripheral device 624. VGI enables a plurality of GPIO signals to be serialized into virtual GPIO signals that can be transmitted over a communication link 622. In one example, virtual GPIO signals may be encoded in packets that are transmitted over a communication link 622 that includes a multi-wire bus, including a serial bus. When the communication link 622 is provided as serial bus, the receiving peripheral device 624 may deserialize received packets and may extract messages and virtual GPIO signals. A VGI FSM 626 in the peripheral device 624 may convert the virtual GPIO signals to physical GPIO signals that can be presented at an internal GPIO interface.

In another example, the communication link 622 may be a provided by a radio frequency transceiver that supports wireless communication using, for example, a Bluetooth protocol, a wireless local area network (WLAN) protocol, a cellular wide area network, and/or another wireless communication protocol. When the communication link 622 includes a wireless connection, messages and virtual GPIO signals may be encoded in packets, frames, subframes, or other structures that can be transmitted over the communication link 622, and the receiving peripheral device 624 may extract, deserialize and otherwise process received signaling to obtain the messages and virtual GPIO signals. Upon receipt of messages and/or virtual GPIO signals, the VGI FSM 626 or another component of the receiving device may interrupt its host processor to indicate receipt of messages and/or any changes in in GPIO signals.

In an example in which the communication link 622 is provided as a serial bus, messages and/or virtual GPIO signals may be transmitted in packets configured for an I2C, I3C, RFFE or another standardized serial interface. In the illustrated example, VGI techniques are employed to accommodate I/O bridging between an Application Processor 602 and a peripheral device 624. The Application Processor 602 may be implemented as an ASIC, SoC or some combination of devices. The Application Processor 602 includes a processor (central processing unit or CPU 604) that generates messages and GPIO associated with one or more communications channels 606. GPIO signals and messages produced by the communications channels 606 may be monitored by respective monitoring circuits 612, 614 in a VGI FSM 626. In some examples, a GPIO monitoring circuit 612 may be adapted to produce virtual GPIO signals representative of the state of physical GPIO signals and/or changes in the state of the physical GPIO signals. In some examples, other circuits are provided to produce the virtual GPIO signals representative of the state of physical GPIO signals and/or changes in the state of the physical GPIO signals.

An estimation circuit 618 may be configured to estimate latency information for the GPIO signals and messages, and may select a protocol, and/or a mode of communication for the communication link 622 that optimizes the latency for encoding and transmitting the GPIO signals and messages. The estimation circuit 618 may maintain protocol and mode information 616 that characterizes certain aspects of the communication link 622 to be considered when selecting the protocol, and/or a mode of communication. The estimation circuit 618 may be further configured to select a packet type for encoding and transmitting the GPIO signals and messages. The estimation circuit 618 may provide configuration information used by a packetizer 620 to encode the GPIO signals and messages. In one example, the configuration information is provided as a command that may be encapsulated in a packet such that the type of packet can be determined at a receiver. The configuration information, which may be a command, may also be provided to physical layer circuits (PHY 608). The PHY 608 may use the configuration information to select a protocol and/or mode of communication for transmitting the associated packet. The PHY 608 may then generate the appropriate signaling to transmit the packet.

The peripheral device 624 may include a VGI FSM 626 that may be configured to process data packets received from the communication link 622. The VGI FSM 626 at the peripheral device 624 may extract messages and may map bit positions in virtual GPIO signals onto physical GPIO pins in the peripheral device 624. In certain embodiments, the communication link 622 is bidirectional, and both the Application Processor 602 and a peripheral device 624 may operate as both transmitter and receiver.

The PHY 608 in the Application Processor 602 and a corresponding PHY 628 in the peripheral device 624 may be configured to establish and operate the communication link 622. The PHY 608 and 628 may be coupled to, or include a wireless transceiver 108 (see FIG. 1) that supports wireless communications. In some examples, the PHY 608 and 628 may support a two-wire interface such an I2C, I3C, RFFE or SMBus interface at the Application Processor 602 and peripheral device 624, respectively and virtual GPIO and messages may be encapsulated into a packet transmitted over the communication link 622, which may be a multi-wire serial bus or multi-wire parallel bus for example.

VGI tunneling, as described herein, can be implemented using existing or available protocols configured for operating the communication link 622, and without the full complement of physical GPIO pins. VGI FSMs 610, 626 may handle GPIO signaling without intervention of a processor in the Application Processor 602 and/or in the peripheral device 624. The use of VGI can reduce pin count, power consumption, and latency associated with the communication link 622.

At the receiving device virtual GPIO signals are converted into physical GPIO signals. Certain characteristics of the physical GPIO pins may be configured using the virtual GPIO signals. For example, slew rate, polarity, drive strength, and other related parameters and attributes of the physical GPIO pins may be configured using the virtual GPIO signals. Configuration parameters used to configure the physical GPIO pins may be stored in configuration registers associated with corresponding GPIO pins. These configuration parameters can be addressed using a proprietary or conventional protocol such as I2C, I3C or RFFE. In one example, configuration parameters may be maintained in I3C addressable registers. Certain aspects disclosed herein relate to reducing latencies associated with the transmission of configuration parameters and corresponding addresses (e.g., addresses of registers used to store configuration parameters).

The VGI interface enables transmission of messages and virtual GPIOs, whereby virtual GPIOs, messages, or both can be sent in the serial data stream over a wired or wireless communication link 622. In one example, a serial data stream may be transmitted in packets and/or as a sequence of transactions over an I2C, I3C or RFFE bus. The presence of virtual GPIO data in I2C/I3C frame may be signaled using a special command code to identify the frame as a VGPIO frame. VGPIO frames may be transmitted as broadcast frames or addressed frames in accordance with an I2C or I3C protocol. In some implementations, a serial data stream may be transmitted in a form that resembles a universal asynchronous receiver/transmitter (UART) signaling protocol, in what may be referred to as VGI_UART mode of operation.

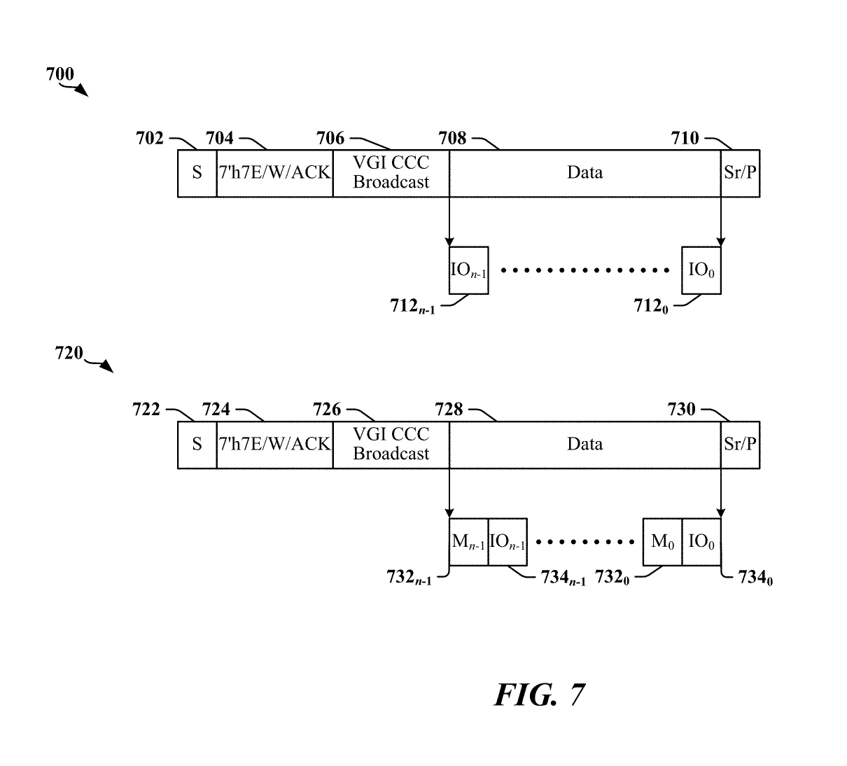

FIG. 7 illustrates examples of broadcast frames 700, 720 for carrying VGI/VGPIO information on an I3C interface. In a first example, a broadcast frame 700 commences with a start bit 702 (S) followed by a header 704 in accordance with an I2C or I3C protocol. A broadcast frame may be identified using a VGI broadcast common command code 706. A VGPIO data payload 708 includes a number (n) of virtual GPIO signals 712₀-712ₙ₋₁, ranging from a first virtual GPIO signal 712₀ to an nth virtual GPIO signal 712ₙ₋₁. A VGI FSM may include a mapping table that maps bit positions of virtual GPIO signals in a VGPIO data payload 708 to conventional GPIO pins. The virtual nature of the signaling in the VGPIO data payload 708 can be transparent to processors in the transmitting and receiving devices.

In the second example, a masked broadcast frame 720 for carrying VGI/VGPIO information on an I3C interface may be transmitted by a host device to change the state of one or more GPIO pins without disturbing the state of other GPIO pins. In this example, the I/O signals for one or more devices are masked, while the I/O signals in a targeted device are unmasked. The masked broadcast frame 720 commences with a start bit 722 followed by a header 724. A masked broadcast frame 720 may be identified using a masked VGI broadcast common command code 726. The VGPIO data payload 728 may include I/O signal values 734₀-734ₙ₋₁ and corresponding mask bits 732₀-732ₙ₋₁, ranging from a first mask bit M₀ 732₀ for the first I/O signal (IO₀) to an nth mask bit Mₙ₋₁₇32ₙ₋₁ for the nth I/O signal IOₙ₋₁.

A stop bit or synchronization bit (Sr/P 710, 730) terminates the broadcast frame 700, 720. A synchronization bit may be transmitted to indicate that an additional VGPIO payload is to be transmitted. In one example, the synchronization bit may be a repeated start bit in an I2C interface.

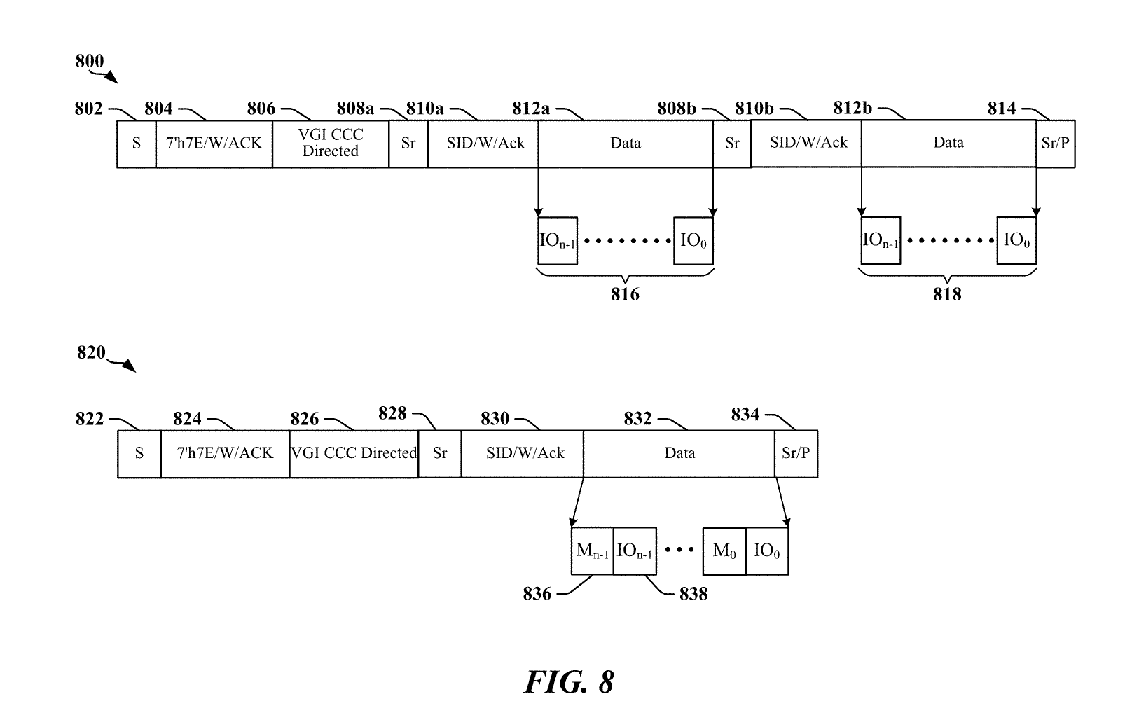

FIG. 8 illustrates examples of directed frames 800, 820 for carrying VGI/VGPIO information on an I3C interface. In a first example, directed frames 800 may be addressed to a single peripheral device or, in some instances, to a group of peripheral devices. The first of the directed frames 800 commences with a start bit 802 (S) followed by a header 804 in accordance with an I2C or I3C protocol. A directed frame 800 may be identified using a VGI directed common command code 806. The directed common command code 806 may be followed by a synchronization field 808a (Sr) and an address field 810a that includes a slave identifier to select the addressed device. The directed VGPIO data payload 812a that follows the address field 810a includes values 816 for a set of I/O signals that pertain to the addressed device. Directed frames 800 can include additional directed payloads 812b for additional devices. For example, the first directed VGPIO data payload 812a may be followed by a synchronization field 808b and a second address field 810b. In this example, the second directed VGPIO payload 812b includes values 818 for a set of I/O signals that pertain to a second addressed device. The use of directed frames 800 may permit transmission of values for a subset or portion of the I/O signals carried in a broadcast frame 700, 720.

In the second example, a masked directed frame 820 may be transmitted by a host device to change the state of one or more GPIO pins without disturbing the state of other GPIO pins in a single peripheral device and without affecting other peripheral devices. In some examples, the I/O signals in one or more devices may be masked, while selected I/O signals in one or more targeted device are unmasked. The masked directed frame 820 commences with a start bit 822 followed by a header 824. A masked directed frame 820 may be identified using a masked directed common command code 826. The masked directed command code 826 may be followed by a synchronization field 828 (Sr) and an address field 830 that includes a slave identifier to select the addressed device. The directed payload 832 that follows includes VGPIO values for a set of I/O signals that pertain to the addressed device. For example, the VGPIO values in the directed data payload 832 may include I/O signal values 838 and corresponding mask bits 836.

A stop bit or synchronization bit (Sr/P 814, 834) terminates the directed frames 800, 820. A synchronization bit may be transmitted to indicate that an additional VGPIO payload is to be transmitted. In one example, the synchronization bit may be a repeated start bit in an I2C interface.

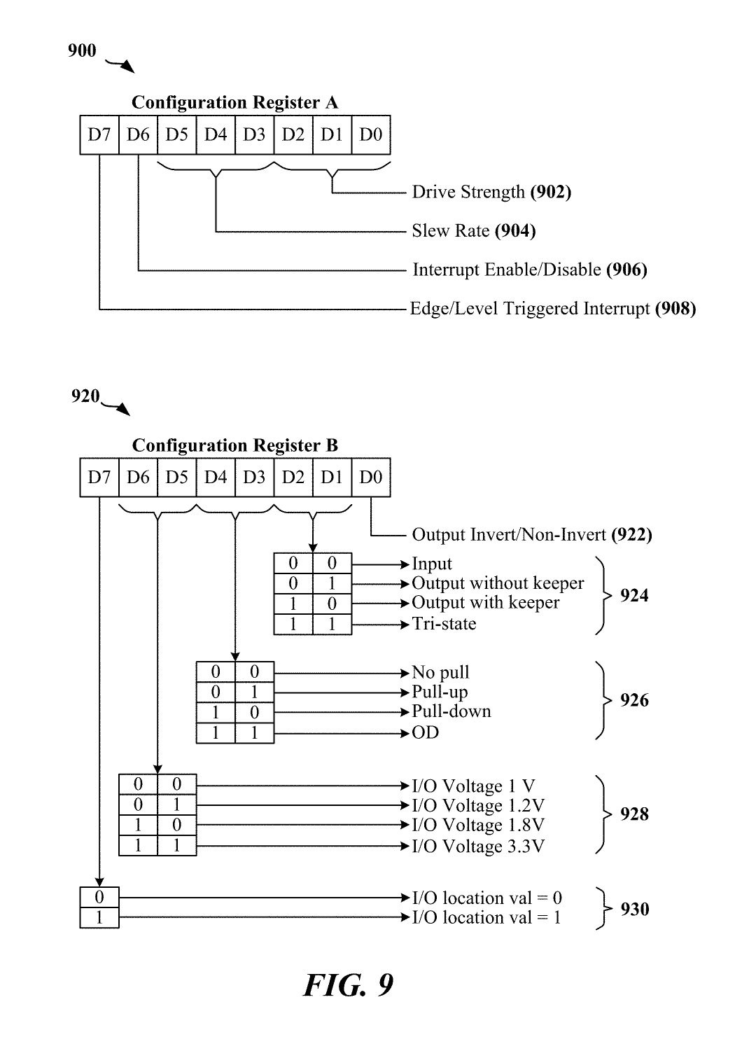

At the receiving device (e.g., the Application Processor 502 and/or peripheral device 504, 506, 508), received virtual GPIO signals are expanded into physical GPIO signal states presented on GPIO pins. The term “pin,” as used herein, may refer to a physical structure such as a pad, pin or other interconnecting element used to couple an IC to a wire, trace, through-hole via, or other suitable physical connector provided on a circuit board, substrate or the like. Each GPIO pin may be associated with one or more configuration registers that store configuration parameters for the GPIO pin. FIG. 9 illustrates configuration registers 900 and 920 that may be associated with a physical pin. Each configuration register 900, 920 is implemented as a one-byte (8 bits) register, where different bits or groups of bits define a characteristic or other features that can be controlled through configuration. In a first example, bits D0-D2 902 control the drive strength for the GPIO pin, bits D3-D5 904 control the slew rate for GPIO pin, bit D6 906 enables interrupts, and bit D7 908 determines whether interrupts are edge-triggered or triggered by voltage-level. In a second example, bit D0 922 selects whether the GPIO pin receives an inverted or non-inverted signal, bits D1-D2 924 define a type of input or output pin, bits D3-D4 926 defines certain characteristics of an undriven pin, bits D5-D6 928 define voltage levels for signaling states, and bit D7 930 controls the binary value for the GPIO pin (i.e., whether GPIO pin carries carry a binary one or zero).

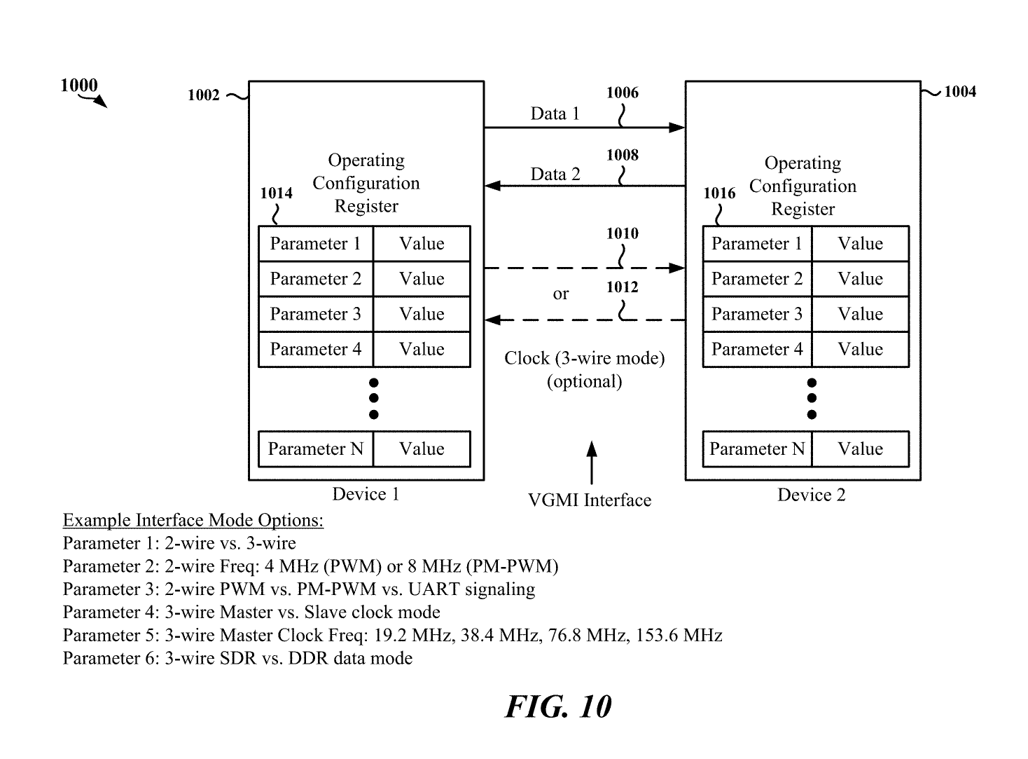

FIG. 10 illustrates a first device 1002 (also referred to as device 1) in communication with a second device 1004 (also referred to as device 2). As shown in FIG. 10, the first device 1002 includes a first operating configuration register 1014, and the second device 1004 includes a second operating configuration register 1016. In some aspects, the first device 1002 may communicate with the second device 1004 through a VGMI interface (e.g., a 2-wire interface including the first wire 1006 and the second wire 1008 in FIG. 10). In some aspects, the first device 1002 may communicate with the second device 1004 through a 3-wire interface (e.g., including the first wire 1006, the second wire 1008, and one of the clock lines 1010, 1012 in FIG. 10).

As shown in FIG. 10, each parameter (e.g., parameter 1, 2, 3 . . . , N) in the operating registers 1014, 1016 may be configured to indicate one or more possible modes of the VGMI interface. For example, parameter 1 may be configured to indicate the 2-wire mode or the 3-wire mode, parameter 2 may be configured to indicate the 2-wire frequency (e.g., 4 MHz (pulse width modulation (PWM)) or 8 MHz (phase modulated pulse width modulation (PM-PWM))), parameter 3 may be configured to indicate the 2-wire mode PWM, PM-PWM, or universal asynchronous receiver/transmitter (UART) signaling, parameter 4 may be configured to indicate the 3-wire mode master clock or 3-wire mode slave clock, parameter 5 may be configured to indicate the 3-wire mode master clock frequency (e.g., 19.2 MHz, 38.4 MHz, 76.8 MHz, 153.6 MHz), and parameter 6 may be configured to indicate the 3-wire mode single data rate (SDR) or the 3-wire mode double data rate (DDR) data modes. Accordingly, in some aspects, the “value” in the configuration registers 1014, 1016 may be the selected mode from among the possible modes represented by a corresponding “parameter”. For example, the value associated with parameter 1 in configuration register 1014 may indicate the 2-wire mode (e.g., where the parameter 1 represents the 2-wire mode vs. 3-wire mode).

The aspects described herein provide a method to establish (or change) the operating configuration of the VGMI interface between the first and second devices 1002, 1004 after the first and second devices 1002, 1004 have powered on and initialized the VGMI interface (e.g., to default operating modes/protocols). In accordance with various aspects of the disclosure, a standardized method of configuring a VGMI interface may include a default start-up mode using PWM signal encoding or any other signaling scheme pre-agreed upon between two devices (e.g., the first and second devices 1002, 1004) in point-to-point (P2P) mode or between the master(s) and slaves(s) in a point-to-multi-point (P2MP) network. In some aspects, a mode-support capability register (MCR) including mode information bits for the interconnected devices may be implemented. The mode-support capability register may enable the interconnected devices to know what modes (e.g., VGMI interface operating modes as described herein) are supported. In some aspects, the mode-support capability register may be based on configuration pins, may be programmable based on available device information, or may be available through a One Time Programmable (OTP) read location. In some aspects, cross-check mode-support and an agree-before-switch (ABS) protocol to switch over to a new mode of operation may be implemented. In some aspects, diversity of signaling modes between pairs of devices in a common network mode connection may be achieved. In some aspects, a favored mode of operation may be retained in a nonvolatile memory of a host processor, such that after a reset, the host processor may indicate each device as what mode to use.

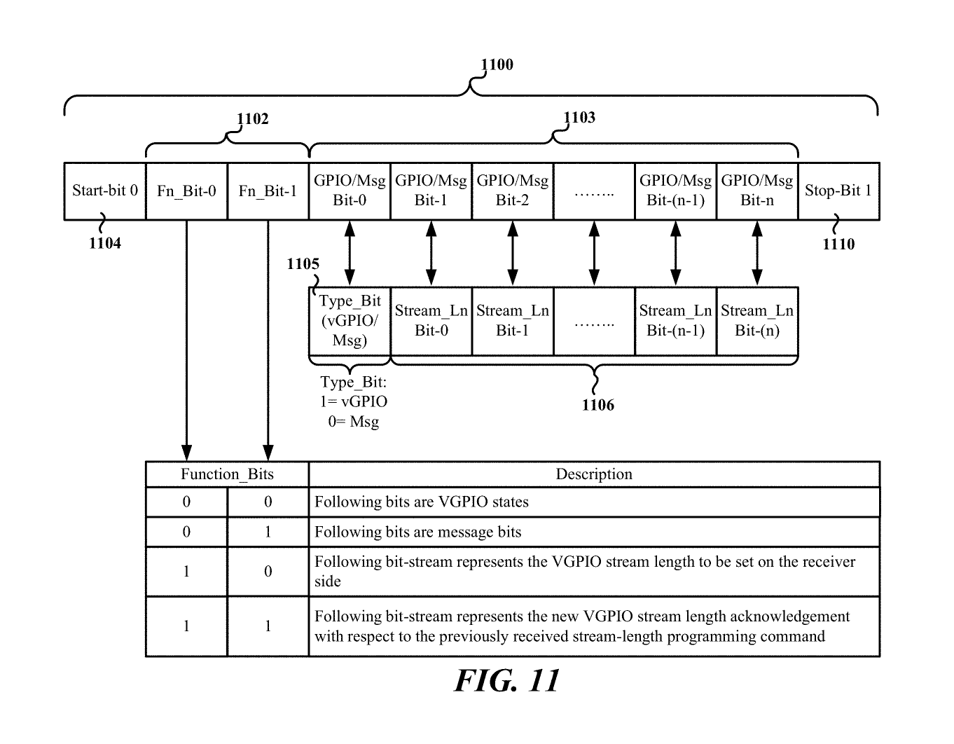

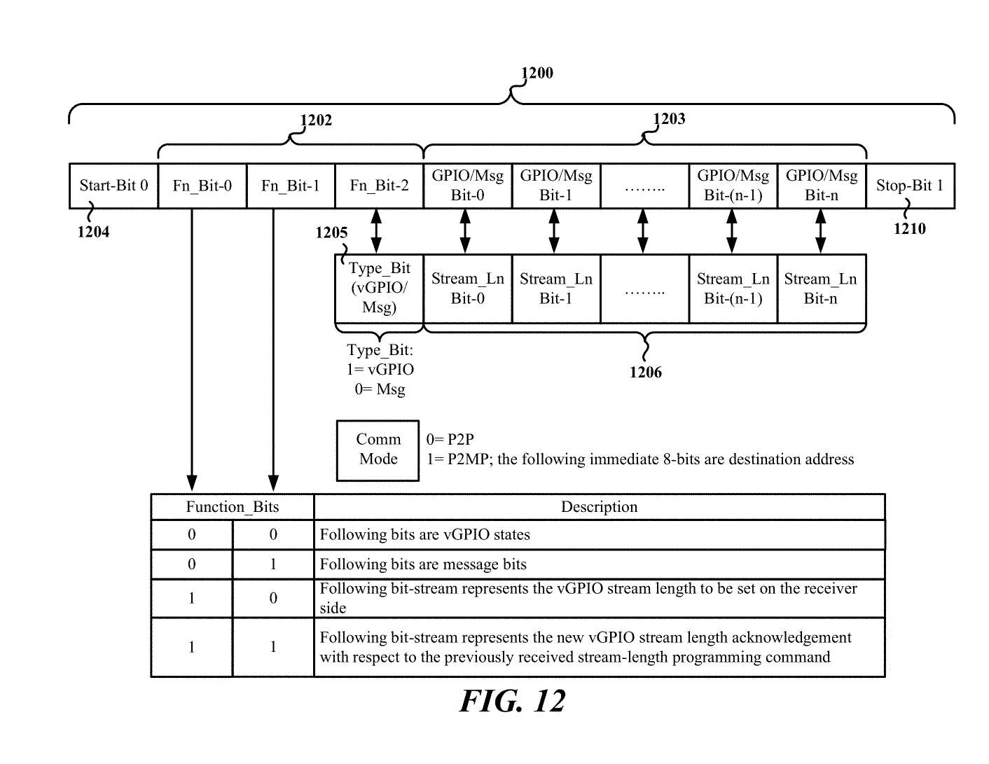

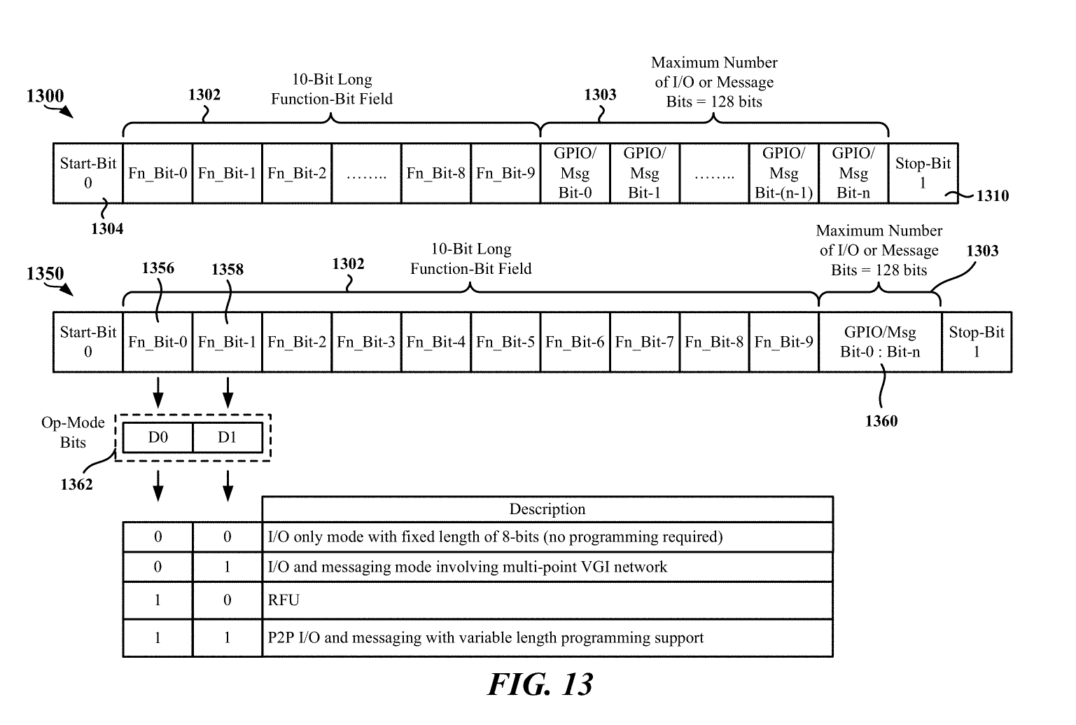

VGMI offers a scalable protocol. Therefore, in some aspects, multiple VGMI packet types may be defined and implemented for the communication of VGMI packets between two or more interconnected devices. Examples of three such VGMI packet types are described herein with reference to FIGS. 11-13. For example, the VGMI packet 1100 in FIG. 11 may represent a Type-1 VGMI packet, the VGMI packet 1200 in FIG. 12 may represent a Type-2 VGMI packet, and the VGMI packet 1300 in FIG. 13 may represent a Type-3 VGMI packet. In some aspects, the Type-1 VGMI packet may be the default VGMI packet configuration following Power-On-Reset of one or more of the interconnected devices. In some aspects, switching between different protocols (e.g., VGMI packet types, such as Type-1, Type-2, Type-3) may be performed by mutual agreement between the two interconnected devices

FIG. 11 shows an example VGMI packet 1100 for communication of VGPIO signals or message signals. The VGMI packet 1100 begins with a start bit 1104 and ends with a stop bit 1110. For example, start bit 1104 may be a logic ‘0’ (e.g., binary zero) and the stop bit 1110 may be a logic ‘1’ (e.g., binary one). A header 1102 may include two function bits (e.g., Fn_Bit-0 and Fn_Bit-1 in FIG. 11). The two function bits in the header 1102 (e.g., Fn_Bit-0 and Fn_Bit-1) may identify whether the subsequent payload 1103 contains VGPIO bits or message bits. In one embodiment, if both function bits are set to logic value ‘0’, the header 1102 identifies the VGMI packet 1100 as containing a VGPIO data payload (e.g., that the following bits are virtual GPIO signals). If the function bit Fn_Bit-0 is set to logic value ‘0’ and the function bit Fn_Bit-1 is set to logic value ‘1’, the header 1102 identifies the VGMI packet 1100 as containing a messaging data payload (e.g., that the following bits are messaging signals). If the function bit Fn_Bit-0 is set to logic value ‘1’ and the function bit Fn_Bit-1 is set to logic value ‘0’, then the following bits represent the virtual GPIO packet length to be expected by the receiving device (also referred to as a remote processor) for subsequent VGMI packets. If both function bits Fn_Bit-0 and Fn_Bit-1 are set to logic value ‘1’, the following bits represent an acknowledgement from the remote processor with respect to the previously received packet-length programming operation. It should be understood that the preceding discussion of coding using two function bits serves an example and that other headers and coding protocols may be used to identify whether a VGMI packet is carrying virtual GPIO signals, messaging signals, an identification of the VGMI packet length, and/or an acknowledgment of the VGMI packet length. In an aspect, the VGMI packet 1100 may also include a third function bit at GPIO/MSG Bit-0 (e.g., the Type_Bit 1105 in FIG. 11). Such third function bit may be associated with programming and acknowledgement packets. For example, in one aspect, the Type_Bit 1105 may be set to logic value ‘1’ to indicate packet length programming (also referred to as link length programming or steam-length programming) for virtual GPIO signals, and may be set to logic value ‘0’ to indicate packet length programming for messaging signals.

In one aspect of the disclosure, to program the length of the VGMI packet 1100, a transmitting VGI FSM (e.g., VGI FSM 610) may set the function bit Fn_Bit-0 to logic value ‘1’ and the function bit Fn_Bit-1 to logic value ‘0’ in the header 1102. The corresponding data payload (e.g., bits 1106 in FIG. 11) in the VGMI packet 1100 would then identify the new packet length. Should a receiving VGI FSM (e.g., VGI FSM 626) support this new packet length, such VGI FSM may transmit an acknowledgement VGMI packet 1100 in which header 1102 has the function bits Fn_Bit-0 and Fn_Bit-1 set to logic value ‘1’. The corresponding data payload (e.g., bits 1106 in FIG. 11) in such an acknowledgement VGMI packet would repeat the packet length identified by the previous programming VGMI packet.

It will be appreciated that variations of VGMI packet 1100 may be used in alternative aspects. However, regardless of the variation, the VGI FSM (e.g., VGI FSM 610, 626) may be preconfigured to decode the header and data payload in such alternative VGMI packet. In some aspects, the VGMI packet 1100 is implemented in point-to-point VGMI links.

FIG. 12 shows an example VGMI packet 1200 for communication of VGPIO signals or message signals. The VGMI packet 1200 begins with a start bit 1204 and ends with a stop bit 1210. For example, the start bit 1204 may be a logic ‘0’ (e.g., binary zero) and the stop bit 1210 may be a logic ‘1’ (e.g., binary one). A header 1202 may include three function bits (e.g., Fn_Bit-0, Fn_Bit-1, and Fn_Bit-2 in FIG. 12). The first two function bits in the header 1202 (e.g., Fn_Bit-0 and Fn_Bit-1) may identify whether the subsequent payload 1203 includes VGPIO bits or message bits. In one aspect, if both function bits Fn_Bit-0 and Fn_Bit-1 are set to logic value ‘0’, the header 1202 identifies the VGMI packet 1200 as containing a VGPIO data payload (e.g., that the following bits in payload 1203 are virtual GPIO signals). If the function bit Fn_Bit-0 is set to logic value ‘0’ and the function bit Fn_Bit-1 is set to logic value ‘1’, the header 1202 identifies the VGMI packet 1200 as containing a messaging data payload (e.g., that the following bits in the payload 1203 are messaging signals).

If the function bit Fn_Bit-0 is set to logic value ‘1’ and the function bit Fn_Bit-1 is set to logic value ‘0’, then the following bits in the payload 1203 (e.g., bits 1206 in FIG. 12) may represent the virtual GPIO packet length or message packet length to be expected by the remote processor during a packet length programming operation. For example, to program the length of the VGMI packet 1200, a transmitting VGI FSM (e.g., VGI FSM 610) may set the function bit Fn_Bit-0 to logic value ‘1’ and the function bit Fn_Bit-1 to logic value ‘0’ in the header 1202. The corresponding data payload (e.g., bits 1206 in FIG. 12) in the VGMI packet 1200 would then identify the new packet length. In an aspect, the function Fn_Bit-2 may be set to logic value ‘1’ to set the length of the virtual GPIO packet, or set to logic value ‘0’ to set the length of the message packet. Should a receiving VGI FSM (e.g., VGI FSM 626) support this new packet length, such VGI FSM may transmit an acknowledgement VGMI packet 1200 in which header 1202 has the function bits Fn_Bit-0 and Fn_Bit-1 set to logic value ‘1’. The corresponding data payload (e.g., bits 1206 in FIG. 12) in such an acknowledgement VGMI packet would repeat the packet length identified by the previous programming VGMI packet.

In one aspect of the disclosure, the function bit Fn_Bit-2 may be used to indicate a communication mode. For example, when the function bit Fn_Bit-2 is set to logic value ‘0’, a point-to-point communication mode may be indicated, and when the function Fn_Bit-2 is set to logic value ‘1’, a point-to-multipoint communication mode may be indicated (e.g., that the following immediate 8-bits in the payload 1203 are a destination address).

It should be understood that the preceding discussion of coding using three function bits serves as an illustration and that other headers and coding protocols may be used to identify whether a VGMI packet is carrying virtual GPIO signals, messaging signals, an identification of the VGMI packet length, and/or an acknowledgment of the VGMI packet length. It will be appreciated that variations of VGMI packet 1200 may be used in alternative embodiments. However, regardless of the variation, the VGI FSM (e.g., VGI FSM 610, 626) may be preconfigured to decode the header and data payload in such alternative VGMI packet. In some aspects, the VGMI packet 1200 may be implemented in point-to-point VGMI links. The VGMI packet 1200 may not have error-detection and/or correction capability in some aspects.

FIG. 13 shows an example VGMI packet 1300 for communication of VGPIO signals or message signals. The VGMI packet 1300 begins with a start bit 1304 and ends with a stop bit 1310. For example, the start bit 1304 may be a logic ‘0’ (e.g., binary zero) and the stop bit 1310 may be a logic ‘1’ (e.g., binary one). The VGMI packet 1300 may include a header 1302 (also referred to as a function bit field) that may include 10 function bits (e.g., Fn_Bit-0 to Fn_Bit-9 in FIG. 13). The VGMI packet 1300 may further include a payload 1303 that may include a number of virtual GPIO or message bits. In one aspect, the payload 1303 may include a maximum of 128 virtual GPIO bits or 128 message bits (e.g., GPIO/Msg Bit-0 to GPIO/Msg Bit-n in FIG. 13, where n<128).

The VGMI packet 1350 in FIG. 13 is an alternative representation of the previously described VGMI packet 1300, such that the VGMI packet 1350 depicts the maximum number of function bits (e.g., the 10 function bits Fn_Bit-0 to Fn_Bit-9) that may be used. As shown in the VGMI packet 1350, the first two function bits in the header 1302 (e.g., Fn_Bit-0 1356 and Fn_Bit-1 1358) may be used to set the operation mode. Therefore, in some aspects, the first two function bits 1356, 1358 in the header 1302 may serve as operation mode bits 1362 as shown in FIG. 13. In one aspect, if both of the function bits Fn_Bit-0 and Fn_Bit-1 are set to logic value ‘0’, the operation mode is an I/O only mode with a fixed length of 8-bits. In this case, programming of the length of the payload 1303 may not be required. If the function bit Fn_Bit-0 1356 is set to logic value ‘0’ and the function bit Fn_Bit-1 1358 is set to logic value ‘1’, the operation mode is an I/O and messaging mode involving a multipoint VGMI network. If both the function bits Fn_Bit-0 1356 and Fn_Bit-1 1358 are set to logic value ‘1’, the operation mode may be a point-to-point I/O and messaging mode with variable length programming support. The configuration where the function bit Fn_Bit-0 1356 is set to logic value ‘1’ and the function bit Fn_Bit-1 1358 is set to logic value ‘0’ may be reserved for other functions and/or operations. In some aspects of the disclosure, the remaining 8-bits (mode “10”) may be extended Hamming (8,4) coded 8-bit code words defining unique functions. Therefore, the VGMI packet 1350 in FIG. 13 may provide options for expansion to facilitate the addition of new functions.

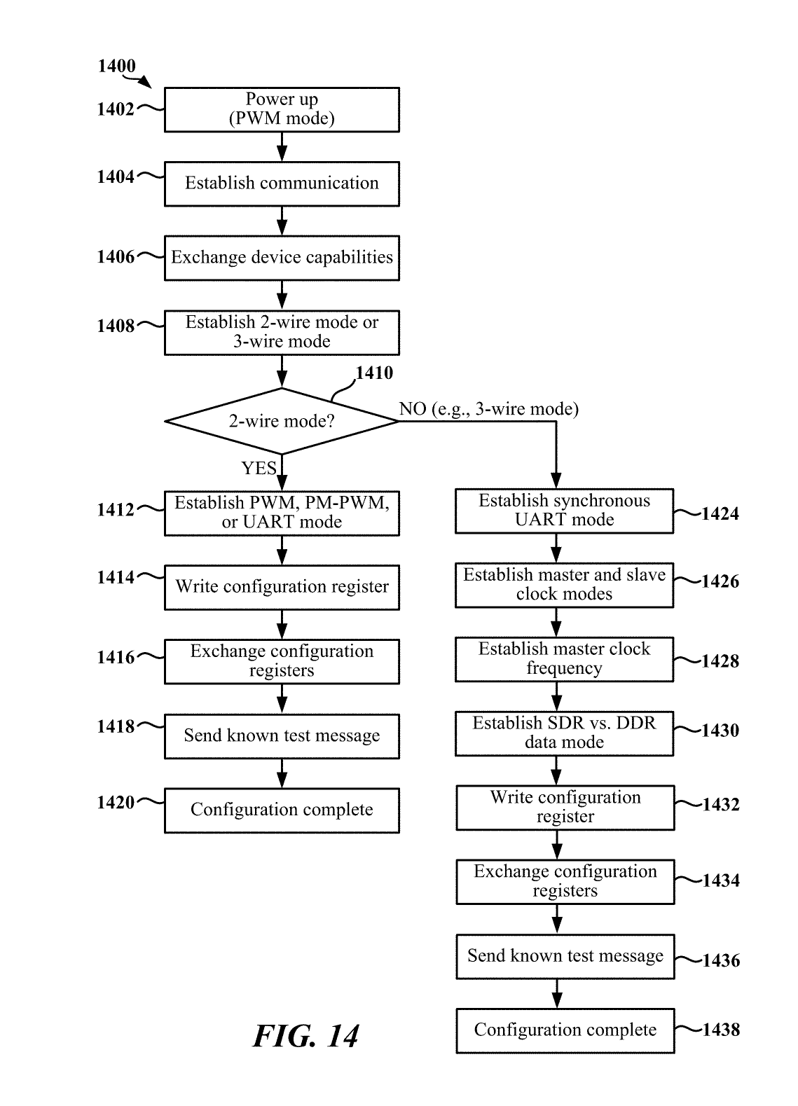

FIG. 14 is an example flowchart 1400 for reconfiguring a VGMI interface in accordance with the various aspects of the disclosure. A device (e.g., the first device 1002) in communication with one or more devices (e.g., the second device 1004), such as in a point-to-point or point-to-multipoint arrangement, may power up in a default VGMI interface configuration 1402. For example, the VGMI interface may be set to implement pulse-width modulation (PWM) for the communication of VMGI packets. The device (e.g., the first device 1002) may establish communication with one or more other devices (e.g., the second device 1004) over the VGMI interface 1404. The device (e.g., the first device 1002) may exchange device capabilities with one or more other devices (e.g., the second device 1004) over the VGMI interface 1406. Such exchange of device capabilities may allow the device to determine the VGMI interface configurations (e.g., protocols and/or modes as described herein) supported by the one or more other devices. The device may establish a 2-wire mode or a 3-wire mode for the VGMI interface 1408.

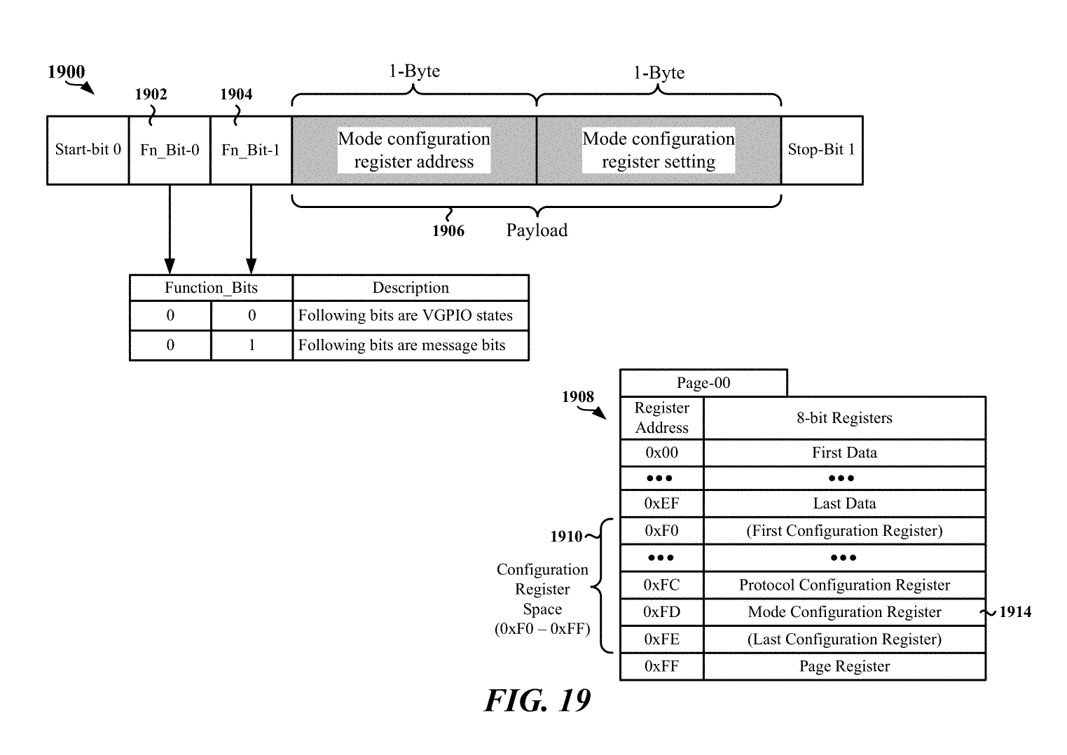

If the device (e.g., the first device 1002) establishes the 2-wire mode 1410, the device may establish the PWM mode, PM-PWM mode, or the UART 1412. The device (e.g., the first device 1002) may write a mode configuration register setting to a VGMI interface configuration register (as described below with respect to FIG. 19) 1414. The device (e.g., the first device 1002) may exchange configuration registers with the one or more other devices (e.g., the second device 1004) 1416. The device (e.g., the first device 1002) may send a known test message to ensure the VGMI interface is configured properly 1418. The device (e.g., the first device 1002) may then complete the configuration method 1420.

If the device (e.g., the first device 1002) does not establish the 2-wire mode and instead establishes the 3-wire mode 1410, the device may establish the synchronous UART mode 1424. The device may establish the master and slave clock modes 1426. The device may establish the master clock frequency 1428. The device may establish the single data rate (SDR) mode or the double data rate (DDR) mode 1430. The device may write a mode configuration register setting to a VGMI interface configuration register (as described below with respect to FIG. 19) 1432. The device (e.g., the first device 1002) may exchange configuration registers with the one or more other devices (e.g., the second device 1004) 1434. The device (e.g., the first device 1002) may send a known test message (e.g., to the second device 1004) to ensure the VGMI interface is configured properly 1436. The device (e.g., the first device 1002) may then complete the configuration method 1438. It should be understood that other variations of the flowchart 1400 are possible depending on the operating modes supported/established by a device.

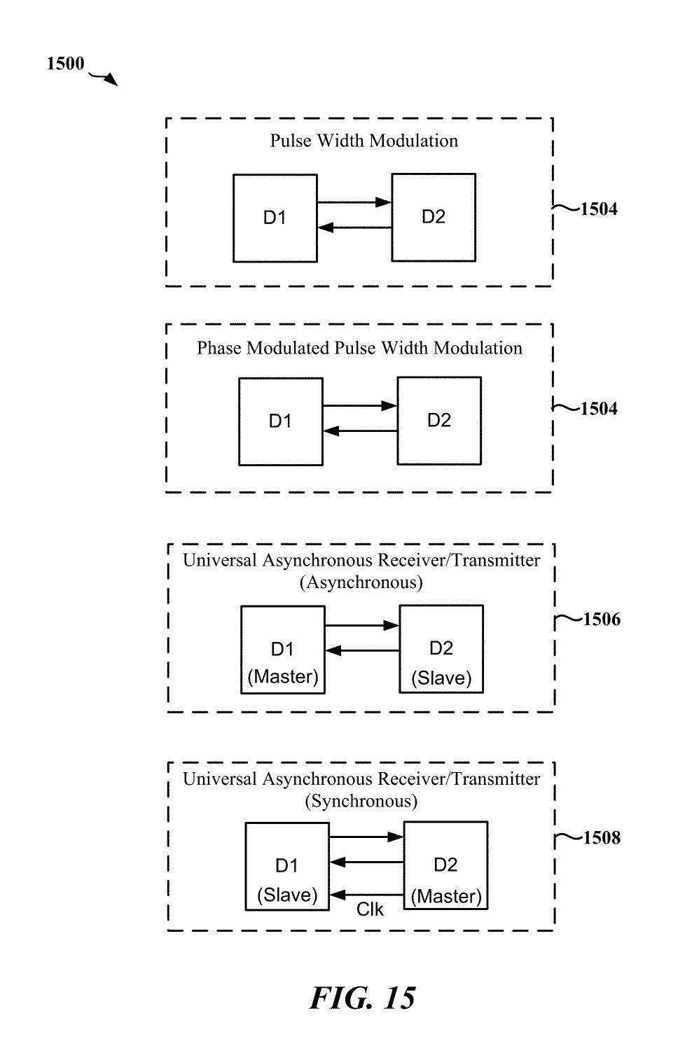

FIG. 15 is a diagram illustrating example configurations of a VGMI interface after initialization in accordance with various aspects of the disclosure. In an aspect, two devices (e.g., device D1 and device D2 in a point-to-point configuration) configured to communicate over a VGMI interface may support the following link parameter options: parameter 1: 2-wire vs. 3-wire, parameter 2: 2-wire Freq: 4 MHz (PWM) or 8 MHz (PM-PWM), parameter 3: 2-wire PWM (4 Mbps) vs. PM-PWM (8 Mbps) vs. UART (4 Mbps) signaling, parameter 4: 3-wire master clock mode vs. slave clock mode, parameter 5: 3-wire master clock frequency 19.2 MHz, 38.4 MHz, 76.8 MHz, or 153.6 MHz, parameter 6: 3-wire SDR vs. DDR data mode, and parameter 7: any other signaling data mode. In some aspects of the disclosure, the device D1 in FIG. 15 may correspond to the first device 1002 in FIG. 10 and the device D2 in FIG. 15 may correspond to the second device 1004 in FIG. 10.

With reference to FIG. 15, in a first example configuration 1502, a VGMI interface between two interconnected devices D1, D2 may be configured to implement pulse-width modulation (PWM). In a second example configuration 1504, a VGMI interface between two interconnected devices D1, D2 may be configured to implement phase modulated pulse-width modulation (PM-PWM). In a third example configuration 1506, a VGMI interface between two interconnected devices D1, D2 may be configured to implement an asynchronous UART interface where D1 is a master and D2 is a slave. In a fourth example configuration 1508, a VGMI interface between two interconnected devices D1, D2 may be configured to implement a 3-wire synchronous UART interface where D1 is a slave and D2 is a master. It should be understood that FIG. 15 includes just four example configurations for ease of illustration and, therefore, may not include all of the possible configurations of the VGMI interface that may be achieved after initialization.

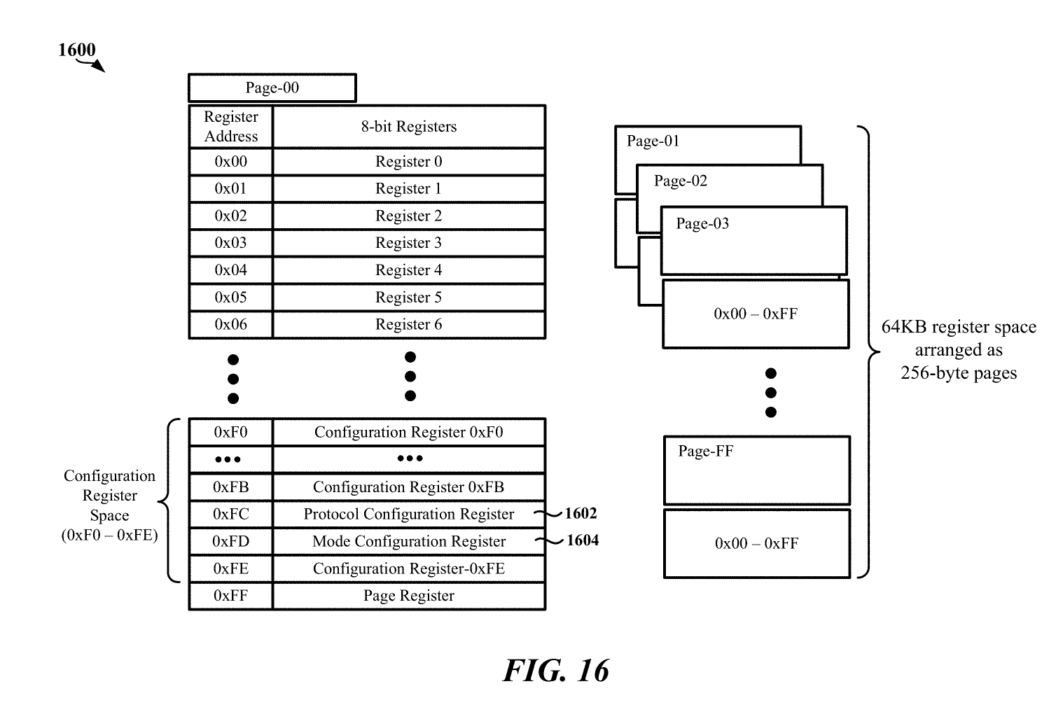

FIG. 16 shows an example implementation of a virtual channel configuration register in accordance with various aspects of the disclosure. As shown in FIG. 16, a 64 KB register space in a memory (e.g., a memory accessible by the interconnect devices, such as the devices 1002, 1004) may be configured as 256-byte pages (e.g., pages 00 to FF). In other words, the 64 KB register space may be configured as 256 pages (e.g., page 00 to page FF), where each page includes 256 8-bit registers. As further shown in FIG. 16, certain 8-bit registers (e.g., 0xF0-0xFE) in a page 1600 (e.g., page 00 as shown in FIG. 6) may be designated as configuration registers. For example, the 8-bit register at register address 0xFC may serve as a protocol configuration register 1602, and the 8-bit register at register address 0xFD may serve as a mode configuration register 1604.

In some aspects, irrespective of the protocol (e.g., Type 1, 2, or 3 VGMI packet type) and/or the mode (1-Wire, 2-Wire, 3-Wire, pulse width modulation (PWM), phase modulated-pulse width modulation (PM-PWM), UART, etc.), the locations of configuration registers 1602, 1604 (e.g., the configuration register addresses) and their functions (e.g., the meanings assigned to the configuration registers) may not change. For example, such locations of configuration registers and/or their functions may be defined in the VGMI specification. In some aspects, register access may always be register-address based.

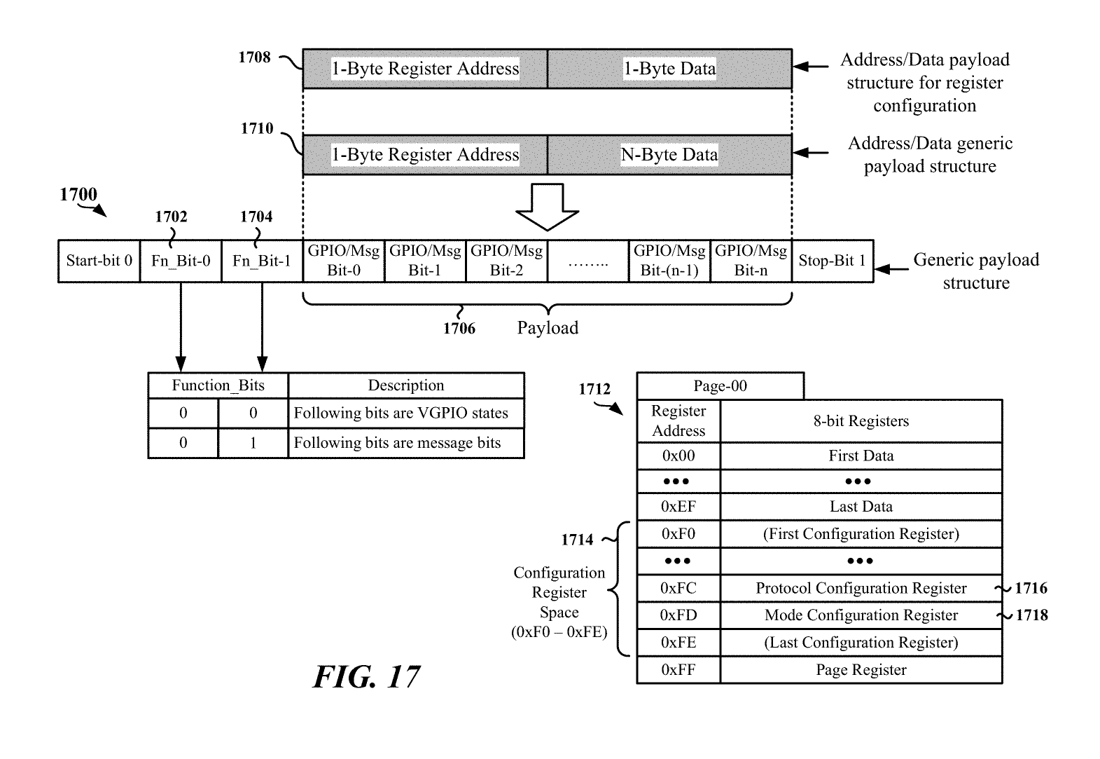

FIG. 17 is an illustration of an address and data payload structure for setting a VGMI configuration register. FIG. 17 includes a VGMI packet structure 1700, which may correspond to the Type-1 VGMI packet 1100 previously described with respect to FIG. 11. In an aspect, the VGMI packet structure 1700 may be used by a device (e.g., the first device 1002) to set a VGMI configuration register. For example, as shown in FIG. 17, the VGMI packet structure 1700 may be used by a device to set the protocol configuration register 1716 and/or the mode configuration register 1718 defined in the example 256-byte page (e.g., page 00) 1712. In an aspect, the 256-byte page 1712 may correspond to the page-00 1600 previously described with respect to FIG. 16. As shown in FIG. 17, the protocol configuration register 1716 and the mode configuration register 1718 may be located in the configuration register space 1714 (e.g., register addresses 0xF0 to 0xFE). In an aspect, the address 0xF0 may be the first configuration address in the configuration register space 1714, and the address 0xFE may be the last configuration address in the configuration register space 1714. In an aspect, one or more configuration registers are in page-00 1712 when the register at address 0xFF contains register setting 0 (e.g. 0x00). The last address (e.g., 0xFF) in page 00 1712 may identify the page number.

In one aspect, a device may obtain configuration data to be written to the a VGMI configuration register (e.g., the protocol configuration register 1716 and the mode configuration register 1718). In this aspect, since the configuration data will be transmitted as message bits in the VGMI packet 1700, the device may set the function bit Fn_Bit-0 1702 to logic value ‘0’ and the function bit Fn_Bit-1 1704 to logic value ‘1’. Therefore, these function bits may indicate to the receiver that the upcoming payload 1706 contains message bits. As shown in FIG. 17, address and data may be included in the payload 1706 according to a first payload structure 1708 or a second payload structure 1710. In an aspect, the first payload structure 1708 is implemented when the VGMI packet structure 1700 is used to set a configuration register, while the second payload structure 1710 is implemented when the VGMI packet structure 1700 is used to communicate data for purposes other than setting a configuration register (e.g., writing data to a register address outside of the configuration register space 1714 on page-00 1712).

As shown in FIG. 17, the first payload structure 1708 may require one byte of address information followed by one byte of data. As further shown in FIG. 17, the second payload structure 1710 may require one byte of address information followed by N bytes of data. In one aspect, the second payload structure 1710 is referred to as a generic payload structure.

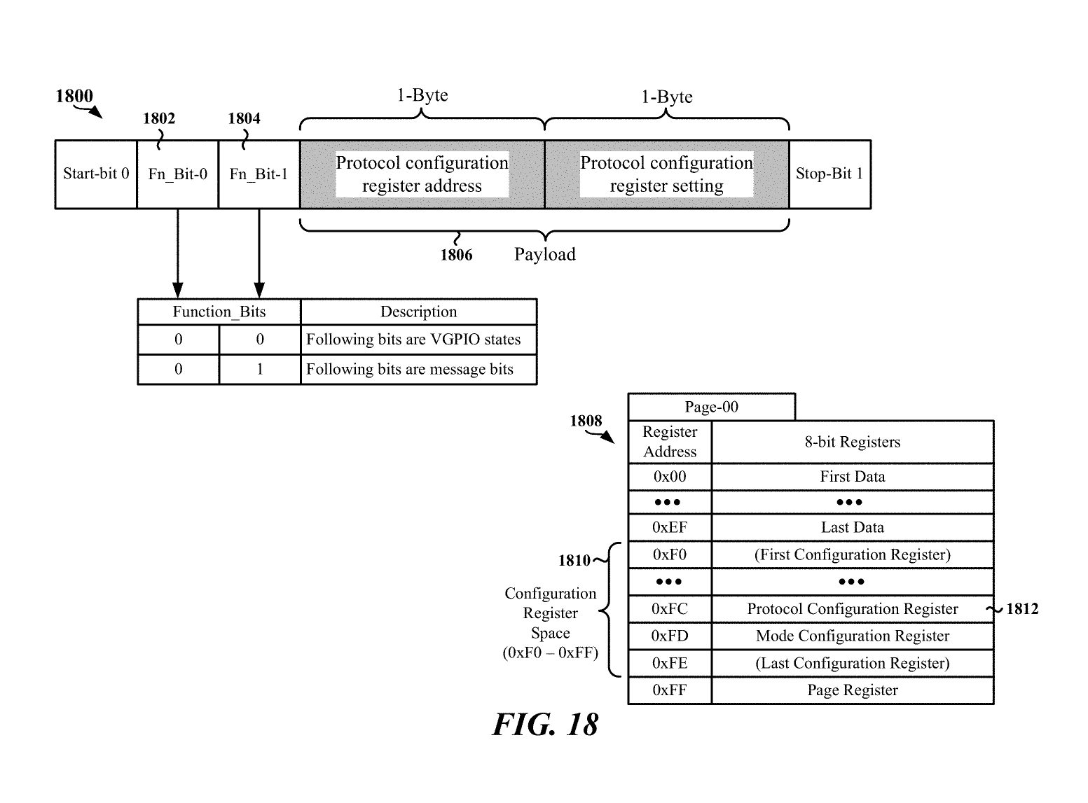

FIG. 18 is an illustration of a VGMI packet structure 1800 for setting a protocol configuration register in accordance with various aspects of the disclosure. In an aspect, the VGMI packet structure 1800 may correspond to the Type-1 VGMI packet 1100 previously described with respect to FIG. 11. For example, a device (e.g., the first device 1002) may use the VGMI packet structure 1800 (also referred to as a configure protocol (CP) message) to set the protocol configuration register 1812 defined in the example 256-byte page (e.g., page-00) 1808. In an aspect, the example 256-byte page 1808 may correspond to the page-00 1600 previously described with respect to FIG. 16 or the example 256-byte page (e.g., page-00) 1712 previously described with respect to FIG. 17.

As shown in FIG. 18, the protocol configuration register 1812 may be located in the configuration register space 1810 (e.g., register addresses 0xF0 to 0xFE). For example, the address 0xF0 may be the first configuration address in the configuration register space 1810, and the address 0xFE may be the last configuration address in the configuration register space 1810. In an aspect, one or more configuration registers are in page-00 1808 when the register at address 0xFF contains register setting 0 (e.g. 0x00). The last address (e.g., 0xFF) in page-00 1810 may identify the page number.

In one aspect, a device (e.g., the first device 1002) may obtain protocol configuration data (also referred to as a protocol configuration register setting) to be written to the protocol configuration register 1812. In this aspect, since the protocol configuration data will be transmitted as message bits in the VGMI packet 1800, the device may set the function bit Fn_Bit-0 1802 to logic value ‘0’ and the function bit Fn_Bit-1 1804 to logic value ‘1’. Therefore, these function bits may indicate to the receiver that the upcoming payload 1806 contains message bits. As shown in FIG. 18, the protocol configuration register address (e.g., the register address 0xFC of the protocol configuration register 1812) and a protocol configuration register setting may be included in the payload 1806. It should be noted that the payload 1806 in this case is configured according to the first payload structure 1708 previously described with respect to FIG. 17. As further shown in FIG. 18, the protocol configuration register address and the protocol configuration register setting are each one-byte.

In some aspects, the VGMI specification-defined addresses may define the type of configuration message to follow. For example, writing a protocol configuration register setting, such as a VGMI packet function bit length (e.g., Fn_Bit length of 2-bit, 3-bit, 10-bit=Type-1, Type-2, Type 3 VGMI packet), to the register address 0xFC may set the protocol configuration register 1812. In one example, if the VGMI function bit length is to be set to three bits, and the corresponding binary value ‘0011’ (which may serve as a protocol configuration register setting) of the VGMI function bit length is written to the register address 0xFC, Type-2 VGMI packets may be used by the device. In another example, if the VGMI function bit length is to be set to 10-bit, and the corresponding binary value ‘1010’ of the VGMI function bit length is written to the register address 0xFC, Type-3 VGMI packets may be used by the device (e.g., the first device 1002).

It should be understood that although the VGMI packet structure 1800 is based on the Type-1 VGMI packet 1100 previously described with respect to FIG. 11, other VGMI packet structures (e.g., the Type-2 VGMI packet 1200 or the Type-3 VGMI packet 1300) may be implemented to obtain a VGMI packet for setting a protocol configuration register. Accordingly, such other VGMI packets for setting a protocol configuration register may have three function bits (e.g., Fn_Bit-0, Fn_Bit-1, and Fn_Bit-2 as shown in FIG. 12) or 10 function bits (e.g., Fn_Bit-0 to Fn_Bit-9 as shown in FIG. 13).

FIG. 19 is an illustration of a VGMI packet structure 1900 for setting a mode configuration register in accordance with various aspects of the disclosure. In an aspect, the VGMI packet structure 1900 may correspond to the Type-1 VGMI packet 1100 previously described with respect to FIG. 11. For example, a device (e.g., the first device 1002) may use the VGMI packet structure 1900 (also referred to as a configure mode (CM) message) to set the mode configuration register 1914 defined in the example 256-byte page (e.g., page-00) 1908. In an aspect, the example 256-byte page-00 1908 may correspond to the page-00 1600 previously described with respect to FIG. 16 or the example 256-byte page (e.g., page-00) 1712 previously described with respect to FIG. 17. It should be noted that the configure mode (CM) message is distinguished from the configure protocol (CP) message. Whereas the configure protocol (CP) message may select a 2-bit VGMI function bit length, 3-bit VGMI function bit length, or a 10-bit VGMI function bit length, the configure mode (CM) message may select one of many operating modes as described in detail herein. As shown in FIG. 19, the mode configuration register 1914 may be located in the configuration register space 1910 (e.g., register addresses 0xF0 to 0xFE). In an aspect, the address 0xF0 may be the first configuration register address in the configuration register space 1910, and the address 0xFE may be the last configuration register address in the configuration register space 1910. In an aspect, one or more configuration registers are included in page-00 1908 when the register at address 0xFF contains register setting 0 (e.g. 0x00). The last address (e.g., 0xFF) in page-00 1908 may identify the page number.

In one aspect, a device (e.g., the first device 1002) may obtain mode configuration data (also referred to as a mode configuration register setting) to be written to the mode configuration register 1914. In this aspect, since the mode configuration register setting will be transmitted as message bits in the VGMI packet 1900, the device may set the function bit Fn_Bit-0 1902 to logic value ‘0’ and the function bit Fn_Bit-1 1904 to logic value ‘1’. Therefore, these function bits may indicate to the receiver that the upcoming payload 1906 contains message bits. As shown in FIG. 19, the mode configuration register address (e.g., the register address 0xFD of the mode configuration register 1914) and the mode configuration register setting may be included in the payload 1906. It should be noted that the payload 1906 in this case is configured according to the first payload structure 1708 previously described with respect to FIG. 17. As further shown in FIG. 19, the mode configuration register address and the mode configuration register setting are each one-byte.

In some aspects, the VGMI specification-defined addresses may define the type of configuration message to follow. For example, consider a device (e.g., the first device 1002) operating in a 2-wire mode. The device may initiate an operating mode change to the 3-wire mode by writing an appropriate mode configuration register setting, such as an 8-bit value indicating the 3-wire mode, to the register address 0xFD. After the mode configuration register 1914 is set with such 8-bit value, the device may begin to operate in the 3-wire mode (e.g., in a scenario where the other interconnected devices can support the 3-wire mode and have mutually agreed to operate in the 3-wire mode). In some aspects, one or more of the interconnected devices (e.g., the second device 1004) communicating over a VGMI interface may be able to support many possible operating modes. For example, the VGMI specification may define 2-wire mode vs. 3-wire mode, 2-wire mode with a frequency of 4 MHz (pulse width modulation (PWM)) vs. 8 MHz (phase modulated pulse width modulation (PM-PWM)), a default mode with 2-wire PWM and 2-bit VGMI function bit length (Type-1 protocol as described herein), 2-wire PWM vs. PM-PWM vs. UART signaling, 3-wire master clock mode vs. slave clock mode, 3-wire master clock frequency of 19.2 MHz, 38.4 MHz, 76.8 MHz, 153.6 MHz, 3-wire SDR vs. DDR data mode. Additional operating modes may include 2-bit (default, Type-1 protocol), 3-bit (Type-2 protocol), or 10-bit (Type-3 protocol) VGMI function bit lengths (also referred to as Fn_Bit length), which may be set using the approaches described herein. In one aspect, a unique 8-bit value may be assigned to each possible operating mode (or combinations of operating modes). For example, the 2-wire mode may be assigned the binary value ‘00000010’, and the 3-wire mode may be assigned the binary value ‘00000011’. For example, the interconnected devices (e.g., the first device 1002 and the second device 1004) may maintain a list of these binary values and their associated operating modes. Accordingly, in this example, a device (e.g., the first device 1002) operating in the 2-wire mode that prefers to switch to the 3-wire mode may obtain the proper 8-bit binary value (e.g., ‘00000011’) corresponding to the 3-wire mode, and may write the obtained 8-bit binary value (which may serve as the mode configuration register setting) to the register address 0xFD using the VGMI packet 1900 as discussed above.

In another aspect, writing to the register address 0xFE may set a configuration register different from those discussed above, such as a virtual channel (VC) configuration register.

It should be understood that although the VGMI packet structure 1900 is based on the Type-1 VGMI packet 1100 previously described with respect to FIG. 11, other VGMI packet structures (e.g., the Type-2 VGMI packet 1200 or the Type-3 VGMI packet 1300) may be implemented to obtain a VGMI packet for setting a mode configuration register. Accordingly, such other VGMI packets for setting a mode configuration register may have 3 function bits (e.g., Fn_Bit-0, Fn_Bit-1, and Fn_Bit-2 as shown in FIG. 12) or 10 function bits (e.g., Fn_Bit-0 to Fn_Bit-9 as shown in FIG. 13).

In an aspect, the 8-bit register address included in a VGMI packet for setting a one VGMI configuration register may be different from the 8-bit register address included in another VGMI packet for setting another VGMI configuration register.

### Exemplary Device and Method

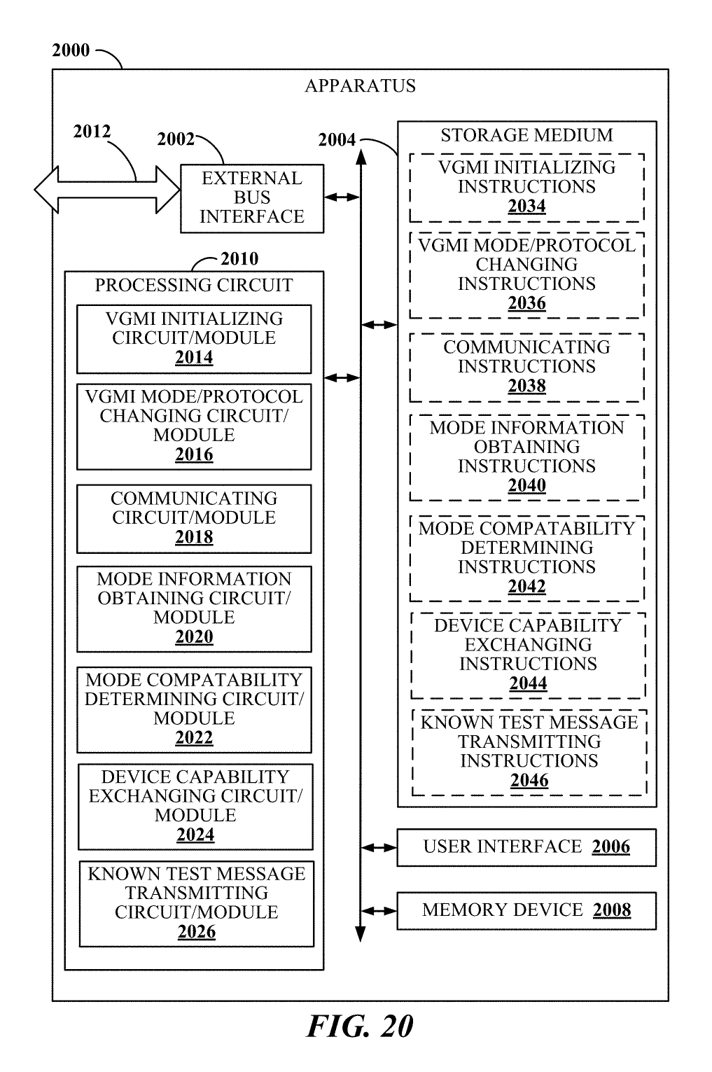

FIG. 20 is block diagram illustrating select components of an apparatus 2000 according to at least one example of the disclosure. The apparatus 2000 includes an external bus interface (or communication interface circuit) 2002, a storage medium 2004, a user interface 2006, a memory device 2008, and a processing circuit 2010. The processing circuit 2010 is coupled to or placed in electrical communication with each of the external bus interface 2002, the storage medium 2004, the user interface 2006, and the memory device 2008.

The external bus interface 2002 provides an interface for the components of the apparatus 2000 to an external bus 2012. The external bus interface 2002 may include, for example, one or more of: signal driver circuits, signal receiver circuits, amplifiers, signal filters, signal buffers, or other circuitry used to interface with a signaling bus or other types of signaling media. In an aspect, the external bus 2012 may include three physical interconnect lines (e.g., the communication link 622 in FIG. 6) for transmitting and receiving VGMI signals and/or I3C signals.

The processing circuit 2010 is arranged to obtain, process and/or send data, control data access and storage, issue commands, and control other desired operations. The processing circuit 2010 may include circuitry adapted to implement desired programming provided by appropriate media in at least one example. In some instances, the processing circuit 2010 may include circuitry adapted to perform a desired function, with or without implementing programming By way of example, the processing circuit 2010 may be implemented as one or more processors, one or more controllers, and/or other structure configured to execute executable programming and/or perform a desired function. Examples of the processing circuit 2010 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 2010 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 2010 are for illustration and other suitable configurations within the scope of the disclosure are also contemplated.

The processing circuit 2010 is adapted for processing, including the execution of programming, which may be stored on the storage medium 2004. As used herein, the terms “programming” or “instructions” shall be construed broadly to include without limitation instruction sets, instructions, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 2010 may include one or more of: a VGMI initializing circuit/module 2014, a VGMI mode/protocol changing circuit/module 2016, a communicating circuit/module 2018, a mode information obtaining circuit/module 2020, a mode capability determining circuit/module 2022, a device capability exchanging circuit/module 2024, or a known test message transmitting circuit/module 2026.

The VGMI initializing circuit/module 2014 may include circuitry and/or instructions (e.g., VGMI initializing instructions 2034 stored on the storage medium 2004) adapted to initialize a virtual general-purpose input/output and messaging interface based on at least one of a first mode configuration setting or a first protocol configuration setting.

The VGMI mode/protocol changing circuit/module 2016 may include circuitry and/or instructions (e.g., VGMI mode/protocol changing instructions 2036 stored on the storage medium 2004) adapted to change the first mode configuration setting of the virtual general-purpose input/output and messaging interface to a second mode configuration setting and/or change the first protocol configuration setting of the virtual general-purpose input/output and messaging interface to a second protocol configuration setting.

The communicating circuit/module 2018 may include circuitry and/or instructions (e.g., communicating instructions 2038 stored on the storage medium 2004) adapted to communicate with the second device over the virtual general-purpose input/output and messaging interface using at least one of the second mode configuration setting or the second protocol configuration setting.

The mode information obtaining circuit/module 2020 may include circuitry and/or instructions (e.g., mode information obtaining instructions 2040 stored on the storage medium 2004) adapted to obtain mode information for at least the second device from a mode-support capability register to determine one or more modes supported by at least the second device, wherein the second mode configuration setting is based on the mode information.

The mode compatibility determining circuit/module 2022 may include circuitry and/or instructions (e.g., mode compatibility determining instructions 2042 stored on the storage medium 2004) adapted to determine that the one or more modes supported by at least the second device are compatible with the apparatus (e.g., the first device).

The device capability exchanging circuit/module 2024 may include circuitry and/or instructions (e.g., device capability exchanging instructions 2044 stored on the storage medium 2004) adapted to exchange device capabilities with at least the second device and/or exchange one or more configuration registers with at least the second device.

The known test message transmitting circuit/module 2026 may include circuitry and/or instructions (e.g., known test message transmitting instructions 2046 stored on the storage medium 2004) adapted to transmit a known test message to at least the second device after changing the first mode configuration setting and/or the first protocol configuration setting of the virtual general-purpose input/output and messaging interface.

The storage medium 2004 may represent one or more processor-readable devices for storing programming, electronic data, databases, or other digital information. The storage medium 2004 may also be used for storing data that is manipulated by the processing circuit 2010 when executing programming The storage medium 2004 may be any available media that can be accessed by the processing circuit 2010, including portable or fixed storage devices, optical storage devices, and various other mediums capable of storing, containing and/or carrying programming By way of example and not limitation, the storage medium 2004 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. Thus, in some implementations, the storage medium may be a non-transitory (e.g., tangible) storage medium.

The storage medium 2004 may be coupled to the processing circuit 2010 such that the processing circuit 2010 can read information from, and write information to, the storage medium 2004. That is, the storage medium 2004 can be coupled to the processing circuit 2010 so that the storage medium 2004 is at least accessible by the processing circuit 2010, including examples where the storage medium 2004 is integral to the processing circuit 2010 and/or examples where the storage medium 2004 is separate from the processing circuit 2010.

Programming/instructions stored by the storage medium 2004, when executed by the processing circuit 2010, causes the processing circuit 2010 to perform one or more of the various functions and/or process steps described herein. For example, the storage medium 2004 may include one or more of: VGMI initializing instructions 2034, VGMI mode/protocol changing instructions 2036, communicating instructions 2038, mode information obtaining instructions 2040, mode capability determining instructions 2042, device capability exchanging instructions 2044, or known test message transmitting instructions 2046. Thus, according to one or more aspects of the disclosure, the processing circuit 2010 is adapted to perform (in conjunction with the storage medium 2004) any or all of the processes, functions, steps and/or routines for any or all of the apparatuses described herein. As used herein, the term “adapted” in relation to the processing circuit 2010 may refer to the processing circuit 2010 being one or more of configured, employed, implemented, and/or programmed (in conjunction with the storage medium 2004) to perform a particular process, function, step and/or routine according to various features described herein.

The memory device 2008 may represent one or more memory devices and may comprise any of the memory technologies listed above or any other suitable memory technology. The memory device 2008 may store information used by one or more of the components of the apparatus 2000. The memory device 2008 also may be used for storing data that is manipulated by the processing circuit 2010 or some other component of the apparatus 2000. In some implementations, the memory device 2008 and the storage medium 2004 are implemented as a common memory component.

The user interface 2006 includes functionality that enables a user to interact with the apparatus 2000. For example, the user interface 2006 may interface with one or more user output devices (e.g., a display device, etc.) and one or more user input devices (e.g., a keyboard, a tactile input device, etc.).

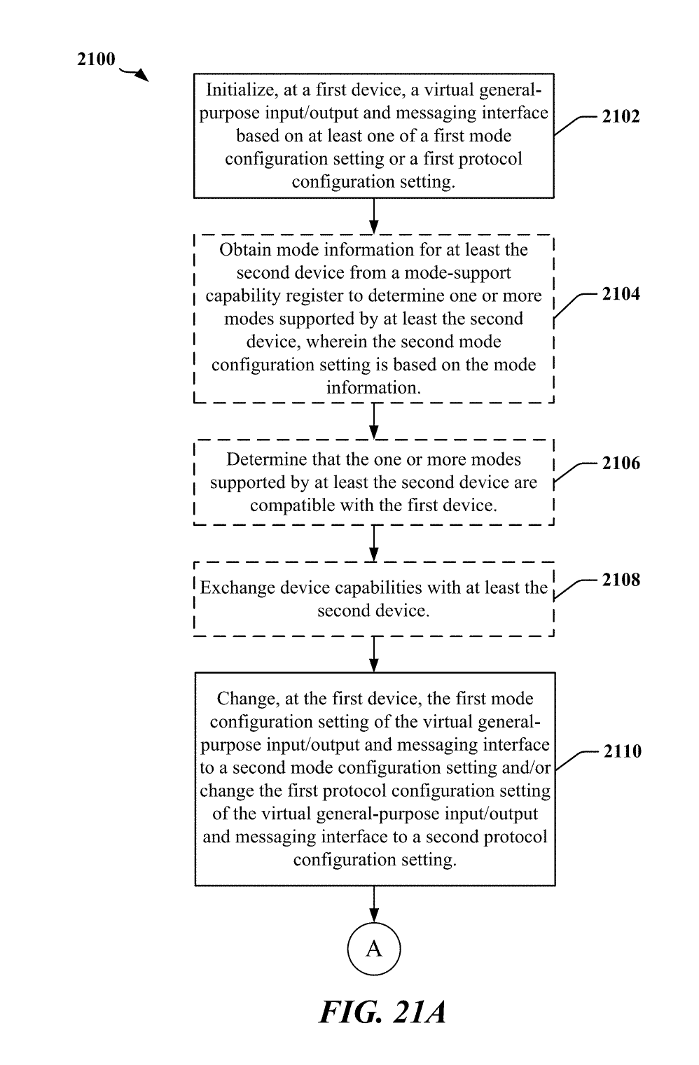

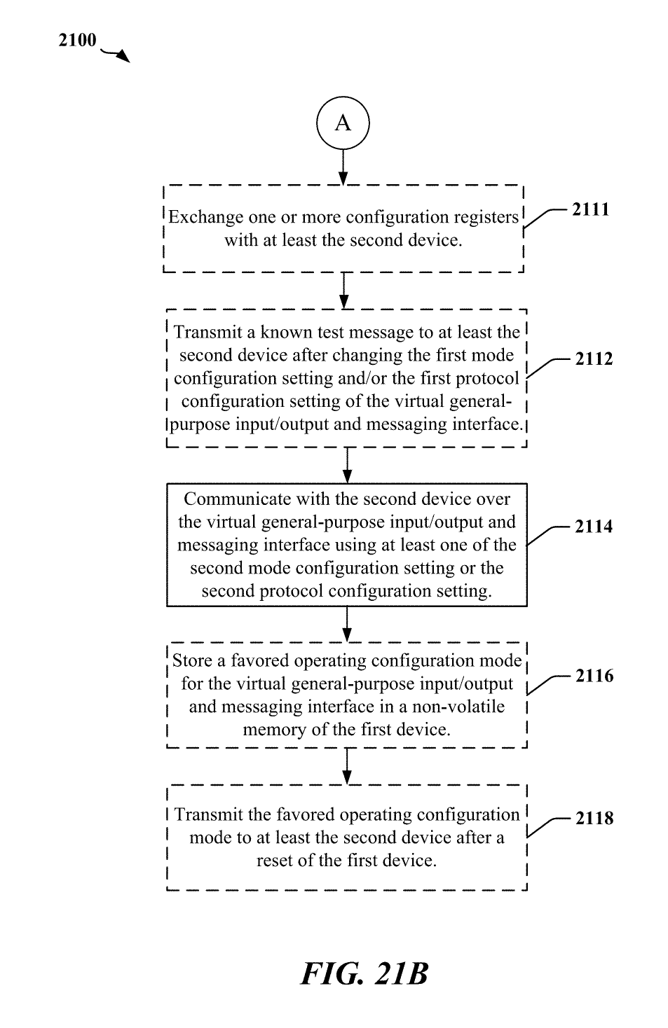

With the above in mind, examples of operations according to the disclosed aspects will be described in more detail in conjunction with the flowchart of FIG. 21 (including FIGS. 21A and 21B). For convenience, the operations of FIG. 21 (or any other operations discussed or taught herein) may be described as being performed by specific components. It should be appreciated, however, that in various implementations these operations may be performed by other types of components and may be performed using a different number of components. It also should be appreciated that one or more of the operations described herein may not be employed in a given implementation.

FIG. 21 (including FIGS. 21A and 21B) is a flowchart 2100 illustrating a method for an apparatus (also referred to herein as a first device), such as the first device 1002 in FIG. 10. For example, the first device may be a transmitter device. It should be understood that the operations in FIG. 21 represented with dashed lines represent optional operations.

The first device initializes a virtual general-purpose input/output and messaging interface based on at least one of a first mode configuration setting or a first protocol configuration setting 2102. In some aspects of the disclosure, the first device is able to communicate with a second device (e.g., the second device 1004 in FIG. 10) over the virtual general-purpose input/output and messaging interface using at least one of the first mode configuration setting or the first protocol configuration setting. The first device obtains mode information for at least the second device from a mode-support capability register to determine one or more modes supported by at least the second device, wherein the second mode configuration setting is based on the mode information 2104. In an aspect, the mode information in the mode-support capability register is based on at least one of one or more configuration pins of the second device, available information for the second device, or a one time programmable read location. The first device determines that the one or more modes supported by at least the second device are compatible with the first device 2106. The first device exchanges device capabilities with at least the second device 2108. The first device changes the first mode configuration setting of the virtual general-purpose input/output and messaging interface to a second mode configuration setting and/or changes the first protocol configuration setting of the virtual general-purpose input/output and messaging interface to a second protocol configuration setting 2110. In an aspect, the first device changes the first mode configuration setting and/or the first protocol configuration setting by obtaining at least one of the second mode configuration setting or the second protocol configuration setting for the virtual general-purpose input/output and messaging interface, and writing at least one of the second mode configuration setting or the second protocol configuration setting to a virtual general-purpose input/output and messaging interface configuration register. In an aspect, the writing at least one of the second mode configuration setting or the second protocol configuration setting to the virtual general-purpose input/output and messaging interface configuration register includes transmitting a first virtual general-purpose input/output and messaging interface packet that includes a mode configuration register address and the second mode configuration setting, or transmitting a second virtual general-purpose input/output and messaging interface packet that includes a protocol configuration register address and the second protocol configuration setting. In an aspect, each of the mode configuration register address, the second mode configuration setting, the protocol configuration register address, and the second protocol configuration setting are 1-byte in length. The first device exchanges one or more configuration registers with at least the second device 2111. The first device transmits a known test message to at least the second device after changing the first mode configuration setting and/or the first protocol configuration setting of the virtual general-purpose input/output and messaging interface 2112. The first device communicates with the second device over the virtual general-purpose input/output and messaging interface using at least one of the second mode configuration setting or the second protocol configuration setting 2114. The first device stores a favored operating configuration mode for the virtual general-purpose input/output and messaging interface in a non-volatile memory of the first device 2116. In an aspect, the first device may be a host processor. The first device transmits the favored operating configuration mode to at least the second device after a reset of the first device 2218.

In an aspect, the second mode configuration setting includes one or more operating modes for the virtual general-purpose input/output and messaging interface. In an aspect, the second protocol configuration setting indicates a 2-bit function bit length, a 3-bit function bit length, or a 10-bit function bit length for communication of packets over the virtual general-purpose input/output and messaging interface.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while exemplary implementations may have been discussed herein as device, system, or method implementations, it should be understood that such exemplary implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like. As used herein, the term “obtaining” may include one or more actions including, but not limited to, receiving, generating, determining, or any combination thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method, comprising:
initializing, at a first device, a virtual general-purpose input/output and messaging interface based on at least one of a first mode configuration setting or a first protocol configuration setting, wherein the first device is able to communicate with a second device over the virtual general-purpose input/output and messaging interface using at least one of the first mode configuration setting or the first protocol configuration setting;
changing, at the first device, the first mode configuration setting of the virtual general-purpose input/output and messaging interface to a second mode configuration setting and/or changing the first protocol configuration setting of the virtual general-purpose input/output and messaging interface to a second protocol configuration setting; and
communicating with the second device over the virtual general-purpose input/output and messaging interface using at least one of the second mode configuration setting or the second protocol configuration setting.

2. The method of claim 1, wherein the changing the first mode configuration setting and/or the first protocol configuration setting comprises:
obtaining, at the first device, at least one of the second mode configuration setting or the second protocol configuration setting for the virtual general-purpose input/output and messaging interface; and
writing at least one of the second mode configuration setting or the second protocol configuration setting to a virtual general-purpose input/output and messaging interface configuration register.

3. The method of claim 2, wherein the writing at least one of the second mode configuration setting or the second protocol configuration setting to the virtual general-purpose input/output and messaging interface configuration register comprises:
transmitting a first virtual general-purpose input/output and messaging interface packet that includes a mode configuration register address and the second mode configuration setting; or
transmitting a second virtual general-purpose input/output and messaging interface packet that includes a protocol configuration register address and the second protocol configuration setting.

4. The method of claim 3, wherein each of the mode configuration register address, the second mode configuration setting, the protocol configuration register address, and the second protocol configuration setting are 1-byte in length.

5. The method of claim 2, further comprising:
obtaining mode information for at least the second device from a mode-support capability register to determine one or more modes supported by at least the second device, wherein the second mode configuration setting is based on the mode information.

6. The method of claim 5, further comprising:
determining that the one or more modes supported by at least the second device are compatible with the first device.

7. The method of claim 1, further comprising:
exchanging device capabilities with at least the second device.

8. The method of claim 1, further comprising:
storing a favored operating configuration mode for the virtual general-purpose input/output and messaging interface in a non-volatile memory of the first device; and
transmitting the favored operating configuration mode to at least the second device after a reset of the first device,
wherein the first device is a host processor.

9. The method of claim 5, wherein the mode information in the mode-support capability register is based on at least one of one or more configuration pins of the second device, available information for the second device, or a one time programmable read location.

10. The method of claim 2, wherein the second mode configuration setting includes one or more operating modes for the virtual general-purpose input/output and messaging interface.

11. The method of claim 2, wherein the second protocol configuration setting indicates a 2-bit function bit length, a 3-bit function bit length, or a 10-bit function bit length for communication of packets over the virtual general-purpose input/output and messaging interface.

12. The method of claim 1, further comprising:
exchanging one or more configuration registers with at least the second device; and
transmitting a known test message to at least the second device after changing the first mode configuration setting and/or the first protocol configuration setting of the virtual general-purpose input/output and messaging interface.

13. An apparatus, comprising:
a communication interface configured to communicate with one or more peripheral devices; and
a processing circuit coupled to the communication interface, the processing circuit configured to
initialize a virtual general-purpose input/output and messaging interface based on at least one of a first mode configuration setting or a first protocol configuration setting, wherein the processing circuit is able to communicate with a device over the virtual general-purpose input/output and messaging interface using at least one of the first mode configuration setting or the first protocol configuration setting;
change the first mode configuration setting of the virtual general-purpose input/output and messaging interface to a second mode configuration setting and/or change the first protocol configuration setting of the virtual general-purpose input/output and messaging interface to a second protocol configuration setting; and
communicate with the device over the virtual general-purpose input/output and messaging interface using at least one of the second mode configuration setting or the second protocol configuration setting.

14. The apparatus of claim 13, wherein the processing circuit configured to change the first mode configuration setting and/or the first protocol configuration setting is further configured to:
obtain at least one of the second mode configuration setting or the second protocol configuration setting for the virtual general-purpose input/output and messaging interface; and
write at least one of the second mode configuration setting or the second protocol configuration setting to a virtual general-purpose input/output and messaging interface configuration register.

15. The apparatus of claim 14, wherein the processing circuit configured to write at least one of the second mode configuration setting or the second protocol configuration setting to the virtual general-purpose input/output and messaging interface configuration register is further configured to:
transmit a first virtual general-purpose input/output and messaging interface packet that includes a mode configuration register address and the second mode configuration setting; or
transmit a second virtual general-purpose input/output and messaging interface packet that includes a protocol configuration register address and the second protocol configuration setting.

16. The apparatus of claim 15, wherein each of the mode configuration register address, the second mode configuration setting, the protocol configuration register address, and the second protocol configuration setting are 1-byte in length.

17. The apparatus of claim 14, wherein the processing circuit is further configured to:
obtain mode information for at least the device from a mode-support capability register to determine one or more modes supported by at least the device, wherein the second mode configuration setting is based on the mode information.

18. The apparatus of claim 17, wherein the processing circuit is further configured to:
determine that the one or more modes supported by at least the device are compatible with the processing circuit.

19. The apparatus of claim 13, wherein the processing circuit is further configured to:
exchange device capabilities with at least the device.

20. The apparatus of claim 13, wherein the processing circuit is further configured to:
store a favored operating configuration mode for the virtual general-purpose input/output and messaging interface in a non-volatile memory of the apparatus; and
transmit the favored operating configuration mode to at least the device after a reset of the processing circuit,
wherein the processing circuit is a host processor.

21. The apparatus of claim 17, wherein the mode information in the mode-support capability register is based on at least one of one or more configuration pins of the device, available information for the device, or a one time programmable read location.

22. The apparatus of claim 14, wherein the second mode configuration setting includes one or more operating modes for the virtual general-purpose input/output and messaging interface.

23. The apparatus of claim 14, wherein the second protocol configuration setting indicates a 2-bit function bit length, a 3-bit function bit length, or a 10-bit function bit length for communication of packets over the virtual general-purpose input/output and messaging interface.

24. The apparatus of claim 13, wherein the processing circuit is further configured to:
exchange one or more configuration registers with at least the device; and
transmit a known test message to at least the device after changing the first mode configuration setting and/or the first protocol configuration setting of the virtual general-purpose input/output and messaging interface.

25. An apparatus, comprising:
means for initializing a virtual general-purpose input/output and messaging interface based on at least one of a first mode configuration setting or a first protocol configuration setting, wherein the apparatus is able to communicate with a device over the virtual general-purpose input/output and messaging interface using at least one of the first mode configuration setting or the first protocol configuration setting;
means for changing the first mode configuration setting of the virtual general-purpose input/output and messaging interface to a second mode configuration setting and/or changing the first protocol configuration setting of the virtual general-purpose input/output and messaging interface to a second protocol configuration setting; and
means for communicating with the device over the virtual general-purpose input/output and messaging interface using at least one of the second mode configuration setting or the second protocol configuration setting.

26. The apparatus of claim 25, wherein the means for changing the first mode configuration setting and/or the first protocol configuration setting is configured to:
obtain at least one of the second mode configuration setting or the second protocol configuration setting for the virtual general-purpose input/output and messaging interface; and
write at least one of the second mode configuration setting or the second protocol configuration setting to a virtual general-purpose input/output and messaging interface configuration register.

27. The apparatus of claim 26, further comprising:
means for obtaining mode information for at least the device from a mode-support capability register to determine one or more modes supported by at least the device, wherein the second mode configuration setting is based on the mode information.

28. The apparatus of claim 27, further comprising:
means for determining that the one or more modes supported by at least the device are compatible with the apparatus.

29. The apparatus of claim 25, further comprising:
means for exchanging device capabilities with at least the device.

30. A processor-readable storage medium having one or more instructions which, when executed by at least one processor or state machine of a processing circuit, cause the processing circuit to:
initialize a virtual general-purpose input/output and messaging interface based on at least one of a first mode configuration setting or a first protocol configuration setting, wherein the processing circuit is able to communicate with a device over the virtual general-purpose input/output and messaging interface using at least one of the first mode configuration setting or the first protocol configuration setting;
change the first mode configuration setting of the virtual general-purpose input/output and messaging interface to a second mode configuration setting and/or change the first protocol configuration setting of the virtual general-purpose input/output and messaging interface to a second protocol configuration setting; and
communicate with the device over the virtual general-purpose input/output and messaging interface using at least one of the second mode configuration setting or the second protocol configuration setting.
